(19) United States
(12) Patent Application Publication
(10) Pub. No.: US 2026/0293885 A1
(43) Pub. Date: Oct. 1, 2026

(54) MICROENCAPSULATED PHEROMONE FORMULATIONS

(71) Applicant: FMC Agricultural Solutions A/S, Harboøre (DK)

(72) Inventor: Charles MANZI-NSHUTI, Philadelphia, PA (US)

(21) Appl. No.: 19/490,157

(22) PCT Filed: Jun. 4, 2024
(86) PCT No.: PCT/US2024/032355

§ 371 Date: Dec. 4, 2025

Related U.S. Application Data
(60) Provisional application No. 63/471,196, filed on Jun. 5, 2023.

(51) Int. Cl. A01N 25/28; A01N 25/02; A01N 31/02; A01N 37/06; A01P 7/00; A01P 17/00

(52) U.S. Cl. CPC A01N 25/28; A01N 25/02; A01N 31/02; A01N 37/06; A01P 7/00; A01P 17/00

(57) ABSTRACT

Described herein are compositions including microencapsulated pheromones. Also described herein are methods of making compositions including microencapsulated pheromones. Also described herein are methods for controlling pests with the compositions.

### CROSS-REFERENCE TO RELATED APPLICATIONS

This application claims the benefit of priority to U.S. Provisional Patent Application No. 63/471,196, filed Jun. 5, 2023, the contents of which are hereby incorporated by reference herein.

### FIELD OF THE DISCLOSURE

Described herein are compositions including microencapsulated pheromones. Also described herein are methods of making compositions including microencapsulated pheromones. Also described herein are methods for controlling pests with the compositions.

### BACKGROUND OF THE DISCLOSURE

Pheromone compositions are difficult to formulate for numerous reasons, including reactions with other ingredients in formulation matrices, degradation of the pheromones over time, and unfavorable release rates of pheromones from formulations. This is particularly true where the pheromones are active agrochemical ingredients and must be delivered at certain release rates over time. Therefore, there is a need in the art for compositions including pheromones that have improved release rate and degradation properties.

Microencapsulation provides a means of formulating pheromones for application to large areas in the control of insect populations by disruption of pheromone-mediated communication. Microencapsulation also helps to control the volatility of the pheromone. However, although microencapsulation of pheromones has been previously demonstrated, there remains a need for improved formulations including microencapsulated pheromones.

The present disclosure provides formulations including microencapsulated pheromones. The formulations possess improved properties compared to conventional formulations including microencapsulated pheromones. The present disclosure enables formulations of pheromones that may be used in sprayable agricultural formulations. Such sprayable formulations are essential for row crop applications.

Formulations including microencapsulated pheromones according to the present disclosure may be manufactured by known methods of interfacial polymerization and they may be applied over large areas with conventional spray equipment. They possess numerous variables that may be manipulated to control the release characteristics (capsule wall composition, capsule wall thickness, capsule size and internal composition.

### BRIEF DESCRIPTION OF THE DISCLOSURE

In one embodiment, the present disclosure is directed to a composition comprising: an antifreeze agent; and a microcapsule comprising: a core comprising: a pheromone; and a solvent; and a shell encapsulating the core; wherein the microcapsule has a d90 value of at least about 30 μm.

In another embodiment, the present disclosure is directed to a method of making a composition, the method comprising: forming a mixture comprising: an antifreeze agent; and a microcapsule comprising: a core comprising: a pheromone; and a solvent; and a shell encapsulating the core; wherein the microcapsule has a d90 value of at least about 30 μm.

In yet another embodiment, the present disclosure is directed to a method for controlling a pest comprising contacting the pest or its environment with a biologically effective amount of a composition comprising: an antifreeze agent; and a microcapsule comprising: a core comprising: a pheromone; and a solvent; and a shell encapsulating the core; wherein the microcapsule has a d90 value of at least about 30 μm.

### DETAILED DESCRIPTION OF THE DISCLOSURE

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”. The use of “consisting essentially of” herein allows the applicant, as lexicographer, to define the invention being claimed by excluding any material, step, feature . . . that is considered by the applicant to be non-critical to the claimed invention, but which may be known in the prior art and otherwise can be included in the invention being claimed, whether or not such inclusion or exclusion is specifically described in the specification. Exclusion of any material, step, feature, etc., by the applicant may be for the sole purpose of excluding elements of the prior art that affect the novelty and, therefore, the patentability of the invention being claimed. As such, the use of “consisting essentially of” herein does not require explicit support from the specification to exclude any element of the prior art from the invention being claimed if inclusion of said element is detrimental to patentability of the invention claimed.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, depending on the context in which it is used, the term “about” provides an estimate of a value associated with the claimed invention, where the estimated value is reasonable when taken in context with the description of the invention and in view of what is known from information available to the public, as such information would be understood or interpreted by a person of ordinary skill in the art. Generally, the term “about” as used herein means that the estimated value will fall within plus or minus 10% of the associated value. The term “about” may be further defined by context, and it is within the applicant's rights as lexicographer to define how “about” should be interpreted within the specific context in which it is used in describing the invention.

As used herein, “wt %” refers to the weight percent of the recited component relative to the total weight of the recited composition.

As used herein, “substantially free” generally refers to no more than 2 wt %. In some embodiments, “substantially free” refers to no more than 1.5 wt %, no more than 1.0 wt %, no more than 0.5 wt %, or no more than 0.1 wt %.

As used herein, a “d10 value” means that the portion of particles with diameters smaller than this value is 10%.

As used herein, a “d50 value” means that the portion of particles with diameters smaller than this value is 50%.

As used herein, a “d90 value” means that the portion of particles with diameters smaller than this value is 90%.

Particle size measurements can be made with a variety of different methods, techniques, and equipment. As described in the present disclosure, the particle sizes are not limited by any measurement method, technique, or equipment. In some embodiments, the particle sizes are measured with a technique selected from light scattering, static light scattering, dynamic light scattering, and combinations thereof. In some embodiments, the particle sizes are measured with a particle size analyzer. In some embodiments, the particle sizes are measured with a particle size analyzer configured to calculate particle size with a Fraunhofer approximation of light scattering. In some embodiments, the particle sizes are measured with a particle size analyzer selected from a Malvern Mastersizer 2000, a Malvern Mastersizer 3000, a HELOS/BR Sucell, and combinations thereof.

As used herein, “antifreeze” refers to a substance that can be added to water or an aqueous mixture to lower the freezing point of the water or aqueous mixture.

In the context of this disclosure “invertebrate pest control” means inhibition of invertebrate pest development (including mortality, feeding reduction, and/or mating disruption), and related expressions are defined analogously.

As referred to in this disclosure, the term “invertebrate pest” includes arthropods, gastropods, nematodes and helminths of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes members of the phylum Nematoda, such as phytophagous nematodes and helminth nematodes parasitizing animals. The term “helminth” includes all of the parasitic worms, such as roundworms (phylum Nematoda), heartworms (phylum Nematoda, class Secernentea), flukes (phylum Platyhelminthes, class Tematoda), acanthocephalans (phylum Acanthocephala), and tapeworms (phylum Platyhelminthes, class Cestoda).

The term “agronomic” refers to the production of field; crops such as for food and fiber and includes the growth of maize or corn, soybeans and other legumes, rice, cereal (e.g., wheat, oats, barley, rye and rice), leafy vegetables (e.g., lettuce, cabbage, and other cole crops), fruiting vegetables (e.g., tomatoes, pepper, eggplant, crucifers and cucurbits), potatoes, sweet potatoes, grapes, cotton, tree fruits (e.g., pome, stone and citrus), small fruit (e.g., berries and cherries) and other specialty crops (e.g., canola, sunflower and olives).

The term “nonagronomic” refers to other than field crops, such as horticultural crops (e.g., greenhouse, nursery or ornamental plants not grown in a field), residential, agricultural, commercial and industrial structures, turf (e.g., sod farm, pasture, golf course, lawn, sports field, etc.), wood products, stored product, agro-forestry and vegetation management, public health (i.e. human) and animal health (e.g., domesticated animals such as pets, livestock and poultry, undomesticated animals such as wildlife) applications.

The term “crop vigor” refers to rate of growth or biomass accumulation of a crop plant. An “increase in vigor” refers to an increase in growth or biomass accumulation in a crop plant relative to an untreated control crop plant. The term “crop yield” refers to the return on crop material, in terms of both quantity and quality, obtained after harvesting a crop plant. An “increase in crop yield” refers to an increase in crop yield relative to an untreated control crop plant.

The term “biologically effective amount” refers to the amount of a biologically active compound sufficient to produce the desired biological effect when applied to (i.e. contacted with) an invertebrate pest to be controlled or its environment, or to a plant, the seed from which the plant is grown, or the locus of the plant (e.g., growth medium) to protect the plant from injury by the invertebrate pest or for other desired effect (e.g., increasing plant vigor).

Nonagronomic applications include protecting an animal from an invertebrate parasitic pest by administering a parasiticidally effective (i.e. biologically effective) amount of a biologically active compound of the disclosure, typically in the form of a composition formulated for veterinary use, to the animal to be protected. As referred to in the present disclosure and claims, the terms “parasiticidal” and “parasiticidally” refers to observable effects on an invertebrate parasite pest to provide protection of an animal from the pest. Parasiticidal effects typically relate to diminishing the occurrence or activity of the target invertebrate parasitic pest. Such effects on the pest include necrosis, death, retarded growth, diminished mobility or lessened ability to remain on or in the host animal, reduced feeding and inhibition of reproduction. These effects on invertebrate parasite pests provide control (including prevention, reduction or elimination) of parasitic infestation or infection of the animal.

It was surprisingly discovered herein that substantial improvements in volatility control of pheromone compositions could be achieved with compositions including an antifreeze and microcapsules, where the microcapsules are relatively large and contain co-encapsulated pheromones and solvents. The most substantial improvements were observed with microcapsules having d90 values of at least 35 μm.

In some embodiments, described herein is a composition including: an antifreeze agent; and a microcapsule including: a core including: a pheromone; and a solvent; and a shell encapsulating the core. The microcapsule has a d90 value of at least about 30 μm.

Generally, compositions according to the present disclosure may include microcapsules of any suitable size known in the art that facilitate the compositions described herein. The size of the microcapsules affects the various characteristics of the encapsulant, as its size indicates the amount of carrier material from which the encapsulant is constructed. Reactivity and stability are directly related to the size of the microcapsules. Another important characteristic affected by the size of the resulting microcapsules is sedimentation in the dispersion and during application of the product. The formulations according to the present disclosure surprisingly exhibit good release rate characteristics for the pheromone and the capsules do not sediment in accelerated storage stability studies.

In some embodiments, the microcapsule has a d90 value in a range of from about 30 μm to about 60 μm. In some embodiments, the microcapsule has a d90 value in a range of from about 35 μm to about 50 μm.

In some embodiments, the microcapsule has a d90 value of at least 30 μm, at least 31 μm, at least 32 μm, at least 33 μm, at least 34 μm, at least 35 μm, at least 36 μm, at least 37 μm, at least 38 μm, at least 39 μm, at least 40 μm, at least 41 μm, at least 42 μm, at least 43 μm, at least 44 μm, at least 45 μm, at least 46 μm, at least 47 μm, at least 48 μm, at least 49 μm, at least 50 μm, at least 51 μm, at least 52 μm, at least 53 μm, at least 54 μm, at least 55 μm, at least 56 μm, at least 57 μm, at least 58 μm, or at least 59 μm. In some embodiments, the microcapsule has a d90 value of at most 31 μm, at most 32 μm, at most 33 μm, at most 34 μm, at most 35 μm, at most 36 μm, at most 37 μm, at most 38 μm, at most 39 μm, at most 40 μm, at most 41 μm, at most 42 μm, at most 43 μm, at most 44 μm, at most 45 μm, at most 46 μm, at most 47 μm, at most 48 μm, at most 49 μm, at most 50 μm, at most 51 μm, at most 52 μm, at most 53 μm, at most 54 μm, at most 55 μm, at most 56 μm, at most 57 μm, at most 58 μm, at most 59 μm, or at most 60 μm.

In some embodiments, the microcapsule has a d50 value in a range of from about 10 μm to about 30 μm. In some embodiments, the microcapsule has a d50 value in a range of from about 15 μm to about 25 μm. In some embodiments, the microcapsule has a d50 value in a range of from about 20 μm to about 22 μm.

In some embodiments, the microcapsule has a d10 value in a range of from about 1 μm to about 7 μm.

Generally, compositions according to the present disclosure may include any suitable auxiliary known in the art that facilitates the compositions described herein. The compositions may include an encapsulated auxiliary and/or a non-encapsulated auxiliary. In some embodiments, the composition includes at least one auxiliary. In some embodiments, the composition includes at least two auxiliaries. In some embodiments, the composition includes at least three auxiliaries. In some embodiments, the composition includes at least four auxiliaries.

In some embodiments, the auxiliary is selected from dispersants, surfactants, emulsifiers, wetting agents, biocides, antifoamers, antifreeze agents, rheology modifiers, solvents, stabilizers, UV stabilizers, UV absorbers, salts, excipients, antioxidants, and combinations thereof.

In some embodiments, the auxiliary comprises a rheology modifier selected from xanthan gum (e.g., Rhodopol 23, Kelzan S), clays, smectite clays, bentonite clays, hectorite clays, magnesium aluminosilicate clays (e.g., Acti-Gel 208, Veegum R), organically modified hectorite clays (e.g., Bentone LF), silica (e.g., Aerosil 200), hydrophobically modifie ethoxylated urethane (HEUR), anionic polyacrylate copolymer hydrophobically modified (HASE), anionic polyacrylate copolymer (ASE), rheology modifiers useful for aqueous systems (e.g., Rheovis rheology modifiers), and combinations thereof.

Generally, compositions according to the present disclosure may include any suitable pheromone known in the art that facilitates the compositions described herein. In some embodiments, the pheromone is selected from aldehyde pheromones, acetate pheromones, alcohol pheromones, ketone pheromones, epoxide pheromones, hydrocarbon pheromones, ester pheromones, and combinations thereof. In some embodiments, the pheromone does not comprise an aldehyde pheromone. Examples of pheromones include Formaldehyde; 2,2-Dibromoacetaldehyde; Acetaldehyde; 2-Methyl-2-propenal; 2-Methylpropanal; 2-Propenal; 3,3-Dibromo-2-propenal; Propanal; 2-Butenal; 2-Methyl-2-butenal; 2-Methylbutanal; 2-Methylenebutanal; 3-Methyl-2-butenal; 3-Methyl-3-butenal; 3-Methylbutanal; Butanal; (E)-2-Pentenal; 2-Methylenepentanal; 2-Pentenal; 3-Methyl-1-(vinyloxy)-butane; 4-Methylpentanal; 4-Pentenal; 5-Methylfurfural; Furan-2-carbaldehyde; Pentanal; (E)-2-Hexenal; (E)-2-Methyl-2-hexenal; (E)-3-Hexenal; (E)-4-oxo-2-Hexenal; (E,E)-2,4-Dimethyl-2,4-hexadienal; (E,E)-2,4-Hexadienal; (Z)-2-Hexenal; (Z)-3-Hexenal; (Z)-4-oxo-2-Hexenal; 1-Hexenal; 2,3-Dihydroxybenzaldehyde; 2-Hexenal; 3-((E)-2-Hexenoxy)-hexanal; 3,5-Dimethylhexanal; 3-Ethoxyhexanal; 3-Hydroxybenzaldehyde; 3-Hydroxyhexanal: 4-Hydroxy-3,5-dimethoxybenzaldehyde; 4-Hydroxybenzaldehyde; 5-Methylhexanal; Hexanal; (IR,2S,5R)-2-Methyl-5-((R)-1-oxopropan-2-yl)-cyclopentanecarbaldehyde; (IR,2S,5S)-2-Methyl-5-((R)-1-oxopropan-2-yl)-cyclopentanecarbaldehyde; (1R,5S)-6,6-Dimethylbicyclo[3.1.1]hept-2-ene-2-carbaldehyde; (1S,2S,5R)-2-Methyl-5-((R)-1-oxopropan-2-yl)-cyclopentanecarbaldehyde; (3S,8R)-2-Methyl-5-(1-formylethyl)-1-cyclopentene-1-carbaldehyde; (3S,8S)-2-Methyl-5-(1-formylethyl)-1-cyclopentene-1-carbaldehyde; (5S,8S)-2-Methyl-5-(1-formylethyl)-1-cyclopentene-1-carbaldehyde; (E)-2-(2-Hydroxyethyl)-6-methyl-2,5-heptadienal; (E)-2-(2-Hydroxyethylidene)-6-methyl-5-heptenal; (E)-2-Heptenal; (E)-2-Isopropyl-5-methyl-2-hexenal; (E)-2-Methyl-2-heptenal; (E,Z)-2,4-Heptadienal; (R)-2,6-Dimethyl-5-heptenal; (S)-4-(Prop-1-en-2-yl)-cyclohex-1-enecarbaldehyde; (Z)-2-Isopropyl-5-methyl-2-hexenal; (Z,Z)-2,4-Heptadienal; 2-(3-Methylcyclopentyl)-propanal; 2-(3-Methylcyclopentyl)-propanal; 2,3,6-Tribromo-4,5-dihydroxy benzaldehyde; 2,3-Dibromo-4,5-dihydroxybenzaldehyde; 2,6-Dimethyl-5-heptenal; 2-Methoxybenzaldehyde; 2-Methyl-1-cyclopentenecarboxaldehyde; 2-Methyl-2-heptenal; 2-Methyl-5-(1-oxopropan-2-yl)-cyclopentanecarbaldehyde; 2-Methylcyclopent-1-enecarbaldehyde; 3,3-Dimethyl-5-oxo-7-oxabicyclo[4.1.0]heptane-1-carbaldehyde; 3,4-Dimethylbenzaldehyde; 3,5-Dibromo-4,5-dihydroxy benzaldehyde; 3,5-Dibromo-4-hydroxybenzaldehyde; 3-Bromo-4,5-dihydroxy benzaldehyde; 3-Bromo-4-hydroxybenzaldehyde; 3-Bromo-5-hydroxy-4-methoxybenzaldehyde; 3-Hydroxybenzene-1,2-dicarbaldehyde; 3-Methylbenzaldehyde; 4-(Heptyloxy)-butanal; 4-Methoxy benzaldehyde; 5-(1-Formylethyl)-2-methyl-2-cyclopentene-1-carbaldehyde; 6-Methyl-5-heptenal; 6-Methylheptanal; Benzaldehyde; Cartilagineal; Cyclohexanedial; Heptanal; Taxifolial D; (IR,2S)-cis-2-Isopropenyl-1-methylcyclobutaneethanal; (1S,2R,3S)-2-(1-Formylvinyl)-5-methylcyclopentanecarbaldehyde; (1S,2S,3S)-2-(1-Formylvinyl)-5-methylcyclopentanecarbaldehyde; (2Z,6E)-8-Chloro-6-chloromethyl-2-methyl-2,6-octadienal; (4S)-(3-Oxoprop-1-en-2-yl)-cyclohex-1-enecarbaldehyde; (E)-(3,3-Dimethyl)-cyclohexylideneacetaldehyde; (E)-2-(3,3-Dimethylcyclohexylidene)-acetaldehyde; (E)-2-(4-Methyl-3-pentenyl)-butenedial; (E)-2-(4-Methyl-3-pentenylidene)-butanedial; (E)-2,7-Octadienal; (E)-2-Methyl-2-octenal; (E)-2-Methyl-5-(3-furyl)-2-pentenal; (E)-2-Octenal; (E)-3,7-Dimethyl-2,6-octadienal; (E)-3,7-Dimethyl-2,6-octadienal; (E)-3-Octenal; (E)-4-oxo-2-Octenal; (E)-7-Methyl-2-octenal; (E,E)-2,4-Octadienal; (E,E)-2,6-Dimethyl-8-hydroxy-2,6-octadienal; (E,E)-2,6-Octadienal; (E,E)-2,6-Octadienedial; (E,Z)-2,4-Octadienal; (E,Z)-2,6-Octadienal; (R)-1,2-Dimethyl-3-methylenecyclopentyl-acetaldehyde; (R)-3,7-Dimethyl-6-octenal; (Z)-(3,3-Dimethyl)-cyclohexylideneacetaldehyde; (Z)-2-(3,3-Dimethylcyclohexylidene)-acetaldehyde; (Z)-3,7-Dimethyl-2,6-octadienal; (Z,E)-3,7-Dimethyl-2,6-octadienal; 1-Octenal; 2-(1-Formylvinyl)-5-methylcyclopentanecarbaldehyde; 2-(3,4-Dihydroxyphenyl)-2-oxoacetaldehyde; 2,6,6-Trimethyl-1-cyclohexene-1-carbaldehyde; 2-Ethyloctanal; 2-Hydroxy-6-methylbenzaldehyde; 2-Methyl benzaldehyde; 2-Methyl-5-(1-formylethyl)-1-cyclopentene-1-carbaldehyde; 2-Octenal; 2-Phenylacetaldehyde; 2-Phenylpropenal; 3,4-Dihydroxyphenylglyoxal; 3,7-Dimethyl-6-octenal; 3-Ethoxy-4-hydroxy benzaldehyde; 3-Ethyl benzaldehyde; 3-Isopropyl-6-methyl benzaldehyde; 3-Octenal; 3-oxo-4-Isopropylidene-1-cyclohexene-1-carboxyaldehyde; 4-Ethylbenzaldehyde; 4-Hydroxy-2-methyl benzaldehyde; 4-Hydroxy-3-methoxybenzaldehyde; 4-Isopropenyl-1-cyclohexene-1-carbaldehyde; 4-Isopropenyl-3-oxo-1-cyclohexene-1-carboxyaldehyde; 4S-4-Isopropenyl-3-oxo-1-cyclohexene-1-carboxyaldehyde; 5-Ethylcyclopent-1-ene-carbaldehyde; 6,6-Dimethylbicyclo[3.1.1]hept-2-ene-2-carbaldehyde; 6-Methyloctanal; 7-Methyloctanal; Anisomorphal; cis-2-Isopropenyl-1-methylcyclobutaneethanal; Octanal; Peruphasmal; (1R,2S,6R)-2,6-Dimethyl-3-oxabicyclo[4.2.0]octane-2-carbaldehyde; (E)-2-Methyl-2-nonenal; (E)-2-Nonenal; (E)-3-Phenyl-2-propenal; (E)-4,8-Nonadienal; (E)-8-Methyl-2-nonenal; (E,E)-2,4-Nonadienal; (E,E,E)-2,4,6-Nonatrienal; (E,E,Z)-2,4,6-Nonatrienal; (E,Z)-2,6-Nonadienal; (E,Z,Z)-2,4,6-Nonatrienal; (Z)-2-Methyl-2-nonenal; (Z)-3-Nonenal; (Z)-4,8-Nonadienal; (Z)-4-Nonenal; (Z)-8-Methyl-2-nonenal; 2,6-Nonadienal; 2-Formyl-3-methylcyclopenteneacetaldehyde; 2-Nonenal; 2-Phenyl-2-butenal; 3-(4-Methoxyphenyl)-2-propenal; 3,5-di-tert-Butyl-4-hydroxybenzaldehyde; 3-Phenyl-2-propenal; 3-Phenylpropanal; 6-Ethyl benzaldehyde; 7,7-Dimethylbicyclo[4.1.0]hept-3-ene-3-carbaldehyde; 7-Methylnonanal; 8-Methylnonanal; 9-Acetyloxynonanal; Gibepyrone C; Nonanal; (4R,8R)-4,8-Dimethyldecanal; (4R,8S)-4,8-Dimethyldecanal; (E)-17,18,19,20-Tetranorloba-8,10,13 (15)-trien-16-al; (E)-2,9-Decadienal; (E)-2-Decenal; (E)-2-Methyl-2-decenal; (E)-2-Methyl-3-(2,3-dibromo-4,5-dihydroxyphenyl)-propenal; (E)-4-oxo-2-Decenal; (E)-8-Hydroxy-4,8-dimethyl-4,9-decadienal; (E)-9-Methyl-2-decenal; (E,E)-2,4-Decadienal; (E,Z)-2,4-Decadienal; (Z)-4-Decenal; (Z)-5-Decenal; (Z)-9-Methyl-2-decenal; (Z,Z)-2,4-Decadienal; 1-Decenal; 2-Decenal; 2-Ethyldecanal; 3-(2,3-Dibromo-4,5-dihydroxyphenyl)-2-methylpropanal; 4,5-Dimethyldecanal; 4,8-Dimethyldecanal; Caraibical; Decanal; Rogiolal; (2E,4E)-2,6,10-Trimethylundeca-2,4,9-trienal; (2E,4E,7Z)-2,6,10-Trimethylundeca-2,4,7,9-tetraenal; (5E)-2,6,10-Trimethylundeca-5,9-dienal; (E)-2-Undecenal; (E)-6-Ethyl-2,10-dimethyl-5,9-undecadienal; (Z)-4-Undecenal; 10-Undecenal; 2-Butyl-2-octenal; 2-Undecenal; 3-Isopropyl-6-methyl-10-oxoundeca-2,6-dienal; 5-Methyl-2-phenyl-2-hexenal; 8-Isopropyl-5-methyl-3,4,4a,5,6,7,8,8a-octahydronaphthalene-2-carbaldehyde; Austrodoral; Oxytoxin 1; syn-4,6-Dimethylundecanal; Taxifolial A; Taxifolial B; Taxifolial C; Undecanal; (1R,6R,7S,10R)-1-Hydroxy-4-cadinen-15-al; (2R,7S,11R)-7-Acetoxy-2-hydroxynardosin-1 (10)-en-12-al; (3R,5R,9R)-3,5,9-Trimethyldodecanal; (3S,6E)-7-Ethyl-3,11-dimethyldodeca-6,10-dienal; (9R)-3,5,9-Trimethyldodecanal; (E)-10-Dodecenal; (E)-2-Dodecenal; (E)-3,7,11-Trimethyl-6,10-dodecadienal; (E)-5-Dodecenal; (E)-6-Dodecenal; (E)-7-Dodecenal; (E)-8-Dodecenal; (E)-9,11-Dodecadienal; (E)-9-Dodecenal; (E,E)-3,7,11-Trimethyl-2,6,10-dodecatrienal; (E,E)-7-Ethyl-3,11-dimethyl-2,6,10-dodecatrienal; (E,E)-8,10-Dodecadienal; (E,E,E)-3,7-Dimethyl-8,11-dioxo-2,6,9-dodecatrienal; (E,E,Z)-3,7-Dimethyl-8,11-dioxo-2,6,9-dodecatrienal; (E,Z)-2,6-Dodecadienal; (E,Z)-5,7-Dodecadienal; (E,Z)-7,9-Dodecadienal; (E,Z)-8,10-Dodecadienal; (R)-10-Oxo-isodauc-3-en-15-al; (S,E)-3,7,11-Trimethyl-6,10-dodecadienal; (Z)-2-Methyl-5-((1R,5R,6S)-2,6-dimethylbicyclo[3.1.1]hept-2-en-6-yl)-pent-2-enal; (Z)-5-Dodecenal; (Z)-7-Dodecenal; (Z)-9,11-Dodecadienal; (Z)-9-Dodecenal; (Z,E)-3,7,11-Trimethyl-2,6,10-dodecatrienal; (Z,E)-5,7-Dodecadienal; (Z,E)-7-Ethyl-3,11-dimethyl-2,6,10-dodecatrienal; (Z,E)-8,10-Dodecadienal; (Z,Z)-5,7-Dodecadienal; 10-Methyldodecanal; 2,10-Dibromo-3-chloro-7-chamigrene; 2-Dodecenal; 2-Ethyldodecanal; 2-Formylguaiazulene; 3,7,11-Trimethyl-(E)-6,10-dodecadienal; 5-Hydroxy-8-methoxycalamanen-15-al; 5-Hydroxy-8-methoxycalamenene-15-al; Aplysinal; Debromoaplysinal; Dodecanal; Parahigginol D; Polygodial; Sclerosporal: Sinuketal; syn-4,6-Dimethyldodecanal; trans-Calamenen-13-al; (3R,5S,9R,7E,11E)-3,5,9,11-Tetramethyl-7,11-tridecadienal; (3S,4R,6E,10Z)-3,4,7,11-Tetramethyl-6,10-tridecadienal; (E,E)-3,5,9,11-Tetramethyltrideca-7,11-dienal; (Z)-4-Tridecenal; 13,14,15,16-Tetranorclerod-3-en-12-al; 13-Acetyloxytridecanal; 4,6-bis(4-Methylpent-3-en-1-yl)-6-methylcyclo-1,3-hexadienecarbaldehyde; Acanthodoral; Ancistrodial; Cespitulin F; Isoacanthodoral; Tridecanal; (E)-11,13-Tetradecadienal; (E)-11-Tetradecenal; (E,E)-8,10-Tetradecadienal; (E,Z)-4,9-Tetradecadienal; (E,Z)-8,10-Tetradecadienal; (Z)-11,13-Tetradecadienal; (Z)-11-Tetradecenal; (Z)-5-Tetradecenal; (Z)-7-Tetradecenal; (Z)-8-Tetradecenal; (Z)-9,13-Tetradecadien-11-ynal; (Z)-9-Tetradecenal; (Z,E)-9,11,13-Tetradecatrienal; (Z,E)-9,11-Tetradecadienal; (Z,E)-9,12-Tetradecadienal; (Z,Z)-5,8-Tetradecadienal; (Z,Z)-8,10-Tetradecadienal; (Z,Z)-9,11-Tetradecadienal; 10,12-Tetradecadienal; 2,4-Tetradecadienal; 2-Ethyltetradecanal; 3-oxo-13-Tetradecenal; 3-oxo-Tetradecanal; 5,8-Tetradecadienal; 5-Tetradecenal; Norasperenal A; Norasperenal B; Norasperenal C; Norasperenal D; Sargasal I; Sargasal II; Tetradecanal; (6R)-6-Acetoxidichotoma-3,14-diene-1,17-dial; (6R)-6-Hydroxydichotoma-3,14-diene-1,17-dial; (E,E)-3,7,11,15-Tetramethyl-6,10,14-hexadecatrienal; (E,Z)-6,8-Pentadecadienal; (E,Z)-9,11-Pentadecadienal; (E,Z,Z)-2,6,9-Pentadecatrienal; (Z)-10-Pentadecenal; (Z)-2-Chloropentadec-2-enal; (Z)-6,14-Pentadecadienal; (Z,Z)-6,9-Pentadecadienal; (Z,Z)-9,11-Pentadecadienal; 2-Hexyl-2-decenal; Azamial A; Azamial B; Isopachydictyolal; Pentadecanal; Sinularial A; Umbellacin A; Xeniafaraunol A; (1R)-Pimaral; (E)-10-Hexadecenal; (E)-11-Hexadecenal; (E)-14-Hexadecenal; (E)-14-Methyl-8-hexadecenal; (E)-3,7,11,15-Tetramethyl-2-hexadecenal; (E,E)-10,12-Hexadecadienal; (E,E)-10,14-Hexadecadienal; (E,E)-11,13-Hexadecadienal; (E,E)-9,11-Hexadecadienal; (E,E,E)-10,12,14-Hexadecatrienal; (E,E,E)-3,7,11,15-tetramethyl-2,6,10,14-hexadecatetraenal; (E,E,Z)-10,12,14-Hexadecatrienal; (E,E,Z)-4,6,11-Hexadecatrienal; (E,E,Z,Z)-4,6,11,13-Hexadecatetraenal; (E,Z)-10,12-Hexadecadienal; (E,Z)-11,13-Hexadecadienal; (E,Z)-4,6-Hexadecadienal; (E,Z)-6,11-Hexadecadienal; (E,Z)-8,11-Hexadecadienal; (E,Z)-9,11-Hexadecadienal; (R)-(E)-14-Methyl-8-hexadecenal; (R)-(Z)-14-Methyl-8-hexadecenal; (S)-(E)-14-Methyl-8-hexadecenal; (S)-(Z)-14-Methyl-8-hexadecenal; (Z)-10-Hexadecenal; (Z)-11-Hexadecenal; (Z)-12-Hexadecenal; (Z)-13-Hexadecen-11-ynal; (Z)-14-Methyl-8-hexadecenal; (Z)-3,7,11,15-Tetramethyl-2-hexadecenal; (Z)-3-oxo-9-Hexadecenal; (Z)-7-Hexadecenal; (Z)-9-Hexadecenal; (Z,E)-10,12-Hexadecadienal; (Z,E)-11,13-Hexadecadienal; (Z,E)-7,11-Hexadecadienal; (Z,E)-9,11-Hexadecadienal; (Z,Z)-10,12-Hexadecadienal; (Z,Z)-11,13-Hexadecadienal; (Z,Z)-7,10-Hexadecadienal; (Z,Z)-7,11-Hexadecadienal; (Z,Z)-9,11-Hexadecadienal; (Z,Z,E)-7,11,13-Hexadecatrienal; 11-Hexadecenal; 11-Hexadecynal; 13(16),14-Spongiadien-19-al; 2-Methylhexadecanal; 7-Hexadecenal; 9-Hexadecenal; Deacetyl-dihydro-nor-thuridillonal; Dictyodial A; Dihydro-nor-thuridillonal; Hexadecanal; Keikipukalide A; Keikipukalide B; Keikipukalide C; Keikipukalide D; Keikipukalide E; Nor-thuridillonal; Pseudoplexaural; Pukalide aldehyde; Sanadaol; (E)-2-Tridecyl-2-heptadecenal; (Z)-9-Heptadecenal; 1-Heptadecenal; 2-Heptadecenal; Globostelletin C; Globostelletin D; Heptadecanal; (E)-11-Octadecenal; (E)-13-Octadecenal; (E)-14-Octadecenal; (E)-2-Octadecenal; (E)-6-Octadecenal; (E,E)-11,14-Octadecadienal; (E,Z)-2,13-Octadecadienal; (E,Z)-3,13-Octadecadienal; (E,Z)-6,11-Octadecadienal; (Z)-11-Octadecenal; (Z)-13-Octadecenal; (Z)-9-Octadecenal; (Z,E)-13,15-Octadecadienal; (Z,Z)-11,13-Octadecadienal; (Z,Z)-13,15-Octadecadienal; (Z,Z)-3,13-Octadecadienal; (Z,Z)-9,12-Octadecadienal; (Z,Z,Z)-9,12,15-Octadecatrienal; 11-Octadecenal; 13,15-Octadecadienal; 13-Octadecenal; 16-Methyloctadecanal; 1-Octadecenal; 3,6-Dihydroxy-24-nor-9-oxo-9,11-secocholesta-7,22-dien-11-al; 9-Octadecenal; Methyloctadecanal; Octadecanal; Panicein B2; Panicein B3; Panicein C; (Z)-10-Nonadecenal; (Z)-9-Nonadecenal; 9 (11)-Pargueren-16-al; Hyrtiosal; Nonadecanal; (2E,6Z,9Z)-2-Methyl-2,6,9-eicosatrienal; (Z)-11-Eicosenal; 11-Eicosenal; 12,18-di-Episcalaradial; 12b-(3′b-Hydroxybutanoyloxy)-20,24-dimethyl-24-oxo-scalara-16-en-25-al; 12b-(3′b-Hydroxypentanoyloxy)-20,24-dimethyl-24-oxo-scalara-16-en-25-al; 12-Deacetoxy-12-oxo-scalaradial; 12-Episcalaradial; 15-Eicosenal; 1-Eicosenal; 3-Deacetyl-22,23-dihydro-24,28-dehydroluffasterol B; 3-Deacetylluffasterol B; 9-Eicosenal; Anthogorgiene B; Deacetylscalaradial; Eicosadienal; Eicosanal; Mooloolabene A; Mooloolabene B; Scalaradial; and combinations thereof.

Of note pheromones include (Z)-5-decenyl acetate, dodecanyl acetate, (Z)-7-dodecenyl acetate, (E)-7-dodecenyl acetate, (Z)-8-dodecenyl acetate, (E)-8-dodecenyl acetate, (Z)-9-dodecenyl acetate, (E)-9-dodecenyl acetate, (E)-10-dodecenyl acetate, 11-dodecenyl acetate, (Z)-9,11-dodecadienyl acetate, (E)-9,11-dodecadienyl acetate, (Z)-11-tridecenyl acetate, (E)-11-tridecenyl acetate, tetradecanyl acetate, (E)-7-tetradecenyl acetate, (Z)-8-tetradecenyl acetate, (E)-8-tetradecenyl acetate, (Z)-9-tetradecenyl acetate, (E)-9-tetradecenyl acetate, (Z)-10-tetradecenyl acetate, (E)-10-tetradecenyl acetate, (Z)-11-tetradecenyl acetate, (E)-11-tetradecenyl acetate, (Z)-12-pentadecenyl acetate, (E)-12-pentadecenyl acetate, hexadecanyl acetate, (Z)-7-hexadecenyl acetate, (Z)-11-hexadecenyl acetate, (E)-11-hexadecenyl acetate, octadecanyl acetate, (E,Z)-7,9-dodecadienyl acetate, (Z,E)-7,9-dodecadienyl acetate, (E,E)-7,9-dodecadienyl acetate, (Z,Z)-7,9-dodecadienyl acetate, (E,E)-8,10-dodecadienyl acetate, (E,Z)-9,12-dodecadienyl acetate, (E,Z)-4,7-tridecadienyl acetate, (E,E)-9,11-tetradecadienyl acetate, (Z,Z)-9,12-tetradecadienyl acetate, (Z,Z)-7,11-hexadecadienyl acetate, (E,Z)-7,11-hexadecadienyl acetate, (Z,E)-7,11-hexadecadienyl acetate, (E,E)-7,11-hexadecadienyl acetate, (Z,E)-3,13-octadecadienyl acetate, (E,Z)-3,13-octadecadienyl acetate, (E,E)-3,13-octadecadienyl acetate, decanol, (Z)-6-nonenol, (E)-6-nonenol, dodecanol, (Z)-5-decenol, 11-dodecenol, (Z)-7-dodecenol, (E)-7-dodecenol, (Z)-8-dodecenol, (E)-8-dodecenol, (E)-9-dodecenol, (Z)-9-dodecenol, (E)-9,11-dodecadienol, (Z)-9,11-dodecadienol, (Z,E)-5,7-dodecadienol, (E,E)-5,7-dodecadienol, (E,E)-8,10-dodecadien-1-ol, (E,Z)-8,10-dodecadienol, (Z,Z)-8,10-dodecadienol, (Z,E)-8,10-dodecadienol, (E,Z)-7,9-dodecadienol, (Z,Z)-7,9-dodecadienol, (E)-5-tetradecenol, (Z)-8-tetradecenol, (Z)-9-tetradecenol, (E)-9-tetradecenol, (Z)-10-tetradecenol, (Z)-11-tetradecenol, (E)-11-tetradecenol, (Z)-11-hexadecenol, (Z,E)-9,11-tetradecadienol, (Z,E)-9,12-tetradecadienol, (Z,Z)-9,12-tetradecadienol, (Z,Z)-10,12-tetradecadienol, (Z,Z)-7,11-hexadecadienol, (Z,E)-7,11-hexadecadienol, (E)-14-methyl-8-hexadecen-1-ol, (Z)-14-methyl-8-hexadecen-1-ol, (E,E)-10,12-hexadecadienol, (E,Z)-10,12-hexadecadienol, dodecanal, (Z)-9-dodecanal, tetradecanal, (Z)-7-tetradecenal, (Z)-9-tetradecenal, (Z)-11-tetradecenal, (E)-11-tetradecenal, (E)-11,13-tetradecadienal, (E,E)-8,10-tetradecadienal, (Z,E)-9,11-tetradecadienal, (Z,E)-9,12-tetradecadienal, hexadecanal, (Z)-8-hexadecenal, (Z)-9-hexadecenal, (Z)-10-hexadecenal, (E)-10-hexadecenal, (Z)-11-hexadecenal, (E)-hexadecenal, (Z)-12-hexadecenal, (Z)-13-hexadecenal, (Z)-14-methyl-8-hexadecenal, (E)-14-methyl-8-hexadecenal, (Z,Z)-7,11-hexadecadienal, (Z,E)-7,11-hexadecadienal, (Z,E)-9,11-hexadecadienal, (E,E)-10,12-hexadecadienal, (E,Z)-10,12-hexadecadienal, (Z,E)-10,12-hexadecadienal, (Z,Z)-10,12-hexadecadienal, (Z,Z)-11,13-hexadecadienal, octadecenal, (Z)-11-octadecenal, (E)-13-octadecenal, (Z)-13-octadecenal, (Z)-5-decenyl 3-methylbutanoate, (+) cis-7,8-epoxy-2-methyloctadecane

Also of note pheromones include citral; geranial; neral; tetradecan-1-al; pentadecan-1-al; pentadecen-1-al; hexadecan-1-al; (Z)-9-hexadecen-1-al; (Z)-11-hexadecen-1-al; (7E,9E)-undeca-7,9-dien-1-al; (11Z,13Z)-hexadecadien-1-al; (9Z,12E)-tetradecadien-1-al; (8E,10E)-dodecadien-1-al; (11Z)-hexadecadien-1-al; (9Z)-tetradecen-1-al; 6,10-dimethyl-5,9-undecadien-2-ol; (6E)-7,11-dimethyl-3-methylene-1,6,10-dodecatriene; [1S-(1a,2b,5a)]-4,6,6-trimethyl-Bicyclo[3.1.1]hept-3-en-2-ol; 10-Hexadecenal; (Z)-10-hexadecenal; (E)-10-hexadecenal; and combinations thereof.

In some embodiments, the pheromone is selected from (Z)-5-decenyl acetate, dodecanyl acetate, (Z)-7-dodecenyl acetate, (E)-7-dodecenyl acetate, (Z)-8-dodecenyl acetate, (E)-8-dodecenyl acetate, (Z)-9-dodecenyl acetate, (E)-9-dodecenyl acetate, (E)-10-dodecenyl acetate, 11-dodecenyl acetate, (Z)-9,11-dodecadienyl acetate, (E)-9,11-dodecadienyl acetate, (Z)-11-tridecenyl acetate, (E)-11-tridecenyl acetate, tetradecanyl acetate, (E)-7-tetradecenyl acetate, (Z)-8-tetradecenyl acetate, (E)-8-tetradecenyl acetate, (Z)-9-tetradecenyl acetate, (E)-9-tetradecenyl acetate, (Z)-10-tetradecenyl acetate, (E)-10-tetradecenyl acetate, (Z)-11-tetradecenyl acetate, (E)-11-tetradecenyl acetate, (Z)-12-pentadecenyl acetate, (E)-12-pentadecenyl acetate, hexadecanyl acetate, (Z)-7-hexadecenyl acetate, (Z)-11-hexadecenyl acetate, (E)-11-hexadecenyl acetate, octadecanyl acetate, (E,Z)-7,9-dodecadienyl acetate, (Z,E)-7,9-dodecadienyl acetate, (E,E)-7,9-dodecadienyl acetate, (Z,Z)-7,9-dodecadienyl acetate, (E,E)-8,10-dodecadienyl acetate, (E,Z)-9,12-dodecadienyl acetate, (E,Z)-4,7-tridecadienyl acetate, (E,E)-9,11-tetradecadienyl acetate, (Z,Z)-9,12-tetradecadienyl acetate, (Z,Z)-7,11-hexadecadienyl acetate, (E,Z)-7,11-hexadecadienyl acetate, (Z,E)-7,11-hexadecadienyl acetate, (E,E)-7,11-hexadecadienyl acetate, (Z,E)-3,13-octadecadienyl acetate, (E,Z)-3,13-octadecadienyl acetate, (E,E)-3,13-octadecadienyl acetate, (Z)-5-decenyl 3-methylbutanoate, (+) cis-7,8-epoxy-2-methyloctadecane, methyl (E,Z)-2,4-decadienoate, methyl 2,6,10-trimethyltridecanoate, and combinations thereof.

In some embodiments, the loading level of the pheromone relative to the entire formulation is in a range of from about 5 wt. % to about 30 wt. %. In some embodiments, the loading level of the pheromone relative to the entire formulation is in a range of from about 10 wt. % to about 25 wt. %. In some embodiments, the loading level of the pheromone relative to the entire formulation is in a range of from about 15 wt. % to about 25 wt. %. The process for achieving a desired loading level includes dissolving the pheromone in an organic phase containing the solvent, and isocyanate monomers, followed by dispersing the organic phase into a second immiscible phase to which is added an amine monomer. The isocyanate monomers and amine monomer react at the droplet surface, forming a polymeric membrane.

In some embodiments, the loading level of the pheromone relative to the entire formulation is at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, or at least about 29 wt. %. In some embodiments, the loading level of the pheromone relative to the entire formulation is at most about 6 wt. %, at most about 7 wt. %, at most about 8 wt. %, at most about 9 wt. %, at most about 10 wt. %, at most about 11 wt. %, at most about 12 wt. %, at most about 13 wt. %, at most about 14 wt. %, at most about 15 wt. %, at most about 16 wt. %, at most about 17 wt. %, at most about 18 wt. %, at most about 19 wt. %, at most about 20 wt. %, at most about 21 wt. %, at most about 22 wt. %, at most about 23 wt. %, at most about 24 wt. %, at most about 25 wt. %, at most about 26 wt. %, at most about 27 wt. %, at most about 28 wt. %, at most about 29 wt. %, or at most about 30 wt. %.

In some embodiments, the percentage of the pheromone in the organic phase is in a range of from about 10 wt. % to about 100 wt. %. In some embodiments, the percentage of the pheromone in the organic phase is in a range of from about 50 wt. % to about 100 wt. %. In some embodiments, the percentage of the pheromone in the organic phase is in a range of from about 70 wt. % to about 100 wt. %.

In some embodiments, the percentage of the pheromone in the organic phase is at least about 10 wt. %, at least about 15 wt. %, at least about 20 wt. %, at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 90 wt. %, or at least about 95 wt. %. In some embodiments, the percentage of the pheromone in the organic phase is at most about 10 wt. %, at most about 15 wt. %, at most about 20 wt. %, at most about 25 wt. %, at most about 30 wt. %, at most about 35 wt. %, at most about 40 wt. %, at most about 45 wt. %, at most about 50 wt. %, at most about 55 wt. %, at most about 60 wt. %, at most about 65 wt. %, at most about 70 wt. %, at most about 75 wt. %, at most about 80 wt. %, at most about 85 wt. %, at most about 90 wt. %, at most about 95 wt. %, or at most about 100 wt. %.

In some embodiments, the percentage of the wall material (isocyanate+amine) relative to the organic phase is in a range of from about 3 wt. % to about 20 wt. %. In some embodiments, the percentage of the wall material (isocyanate+amine) relative to the organic phase is in a range of from about 7 wt. % to about 15 wt. %. In some embodiments, the percentage of the wall material (isocyanate+amine) relative to the organic phase is in a range of from about 10 wt. % to about 16 wt. %. In some embodiments, the percentage of the wall material (isocyanate+amine) relative to the organic phase is in a range of from about 8 wt. % to about 12 wt. %.

In some embodiments, the percentage of the wall material (isocyanate+amine) relative to the organic phase is at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, or at least about 19 wt. %. In some embodiments, the percentage of the wall material (isocyanate+amine) relative to the organic phase is at most about 4 wt. %, at most about 5 wt. %, at most about 6 wt. %, at most about 7 wt. %, at most about 8 wt. %, at most about 9 wt. %, at most about 10 wt. %, at most about 11 wt. %, at most about 12 wt. %, at most about 13 wt. %, at most about 14 wt. %, at most about 15 wt. %, at most about 16 wt. %, at most about 17 wt. %, at most about 18 wt. %, at most about 19 wt. %, or at most about 20 wt. %.

Generally, compositions according to the present disclosure may include any suitable solvent known in the art that facilitates the compositions described herein. The solvent may be a single solvent or a mixture of solvents. In some embodiments, the solvent is selected from hydrophobic solvents including high flashpoint-type solvents, methylated seed oils, methyl oleate methyl ester oil, methyl linoleate methyl ester oil, mineral oils, paraffinic oil, tall oil fatty acid-based solvents, aromatic solvents (e.g., Aromatic 200, Aromatic 200ND), aromatic ester solvents, polybutenes, methyl esters of fatty acids, tributyl 2-acetate citrate, alkyl amides (e.g., Agnique AMD10), benzyl acetate, wax esters, and combinations thereof. In some embodiments, the solvent includes methyl oleate methyl ester oil and methyl linoleate methyl ester oil. In some embodiments, the solvent includes methyl oleate methyl ester oil and methyl linoleate methyl ester oil and a solvent selected from hydrophobic solvents including high flashpoint-type solvents, methylated seed oils, mineral oils, paraffinic oil, tall oil fatty acid-based solvents, aromatic solvents, aromatic ester solvents, polybutenes, methyl esters of fatty acids, tributyl 2-acetate citrate, alkyl amides, benzyl acetate, wax esters, and combinations thereof.

In some embodiments, the pheromone and the solvent are each encapsulated. In some embodiments, the pheromone and the solvent are co-encapsulated. In some embodiments, the pheromone and the solvent are co-encapsulated with at least one auxiliary.

Generally, compositions according to the present disclosure may include any suitable antifreeze agent known in the art that facilitates the compositions described herein. In some embodiments, the antifreeze agent is selected from propylene glycol, glycerin, glycols, ethylene glycol, 1,2-butane diol, 1,3-butane diol, 2,3-butanediol, 1,4-butanediol, methanol, ethanol, propanol, butanol, and combinations thereof. In some embodiments, the antifreeze agent is non-encapsulated. In some embodiments, a portion of the antifreeze agent is encapsulated.

Generally, compositions according to the present disclosure may include any suitable microcapsule shell material known in the art that facilitates the compositions described herein. In some embodiments, the microcapsule shell includes a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

In some embodiments, when the shell comprises polyurea, the polyurea is formed from amines and isocyanates. Suitable amines include diamines, hexamethylenediamine (HMDA), 1,4-diaminobutane, 1,3-diaminopropane, ethylenediamine (EDA), 1,4-cyclohexanediamine, 1,3-cyclohexanebis(methylamine), m-xylylenediamine, and combinations thereof. Suitable isocyanates include polyisocyanates and polyisocyanate prepolymers such as polymethylene polyphenyl isocyanates (e.g., PAPI 27), polymeric diphenyl methane diisocyanate (MDI) (e.g., Rubinate M or Suprasec 5025), isocyanates based on xylylene diisocyanate (XDI), including but not limited to, Takenate™ 500 (XDI), Takenate™ 600 (hydrogenated XDI), Takenate™ D-110N (an adduct of XDI and trimethylol propane), Takenate™ D-131N (an XDI-trimer), and Takenate™ D-120 (an adduct of hydrogenated XDI and trimethylol propane), polyisocyanate-polyol adducts, polyfunctional aliphatic isocyanates, and the like.

In some embodiments, the composition is an agrochemical composition. In some embodiments, the composition is in a form selected from a premix and a tank mix. In some embodiments, the composition is a sprayable composition.

Compositions according to the present disclosure may be in any suitable form of compositions known in the art that facilitates the compositions described herein. Particularly preferred formulations of compositions in accordance with the present disclosure are capsule suspension concentrates (CS), mixed formulations (ZC) that include mixtures of suspension concentrates (SC) and capsule suspension concentrates (CS), mixed formulations (ZW) that include mixtures of emulsions, oil-in-water (EW) and capsule suspension concentrates (CS), and mixed formulations (ZE) that include mixtures of suspoemulsions (SE) and capsule suspension concentrates (CS).

In some embodiments, the composition is in a form of a CS formulation, a ZC formulation, a ZW formulation, or a ZE formulation.

Sprayable formulations are typically extended in a suitable medium before spraying. Such formulations are formulated to be readily diluted in the spray medium, usually water, but occasionally another suitable medium like an aromatic or paraffinic hydrocarbon or vegetable oil. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Formulations can be metered directly into drip irrigation systems or metered into the furrow during planting. Formulations can be applied onto seeds of crops and other desirable vegetation as seed treatments before planting to protect developing roots and other subterranean plant parts and/or foliage through systemic uptake.

The compositions according to the present disclosure may be delivered by an autonomous vehicle. The autonomous vehicle may be a grounded vehicle. The autonomous vehicle may operate during the day and/or night.

The compositions according to the present disclosure may be aerially delivered. The compositions according to the present disclosure may be delivered by an unmanned vehicle or an unmanned aerial vehicle (UAV). The compositions according to the present disclosure may be delivered by a helicopter or fixed-wing airplane.

Generally, compositions according to the present disclosure may be made according to any suitable method known in the art that facilitates the compositions described herein.

In some embodiments, described herein is a method of making a composition, the method comprising: forming a mixture comprising: an antifreeze agent; and a microcapsule comprising: a core comprising: a pheromone; and a solvent; and a shell encapsulating the core; wherein the microcapsule has a d90 value of at least about 30 μm.

In some embodiments, the method further includes encapsulating the pheromone and the solvent in the microcapsule prior to forming the mixture. In these embodiments, the microcapsule is added to the mixture.

In some embodiments, the method includes encapsulating the pheromone and the solvent in the microcapsule in the mixture. In these embodiments, the microcapsule is formed in situ in the mixture by known methods of interfacial polymerization. Microencapsulated formulations prepared by interfacial polymerization are beneficial for at least three reasons: i) they are easily manufactured on a large scale using known technology; ii) they are easily applied over large areas with conventional spray equipment; and iii) they possess numerous variables that can be manipulated to control the release characteristics (e.g. capsule wall thickness, capsule wall composition, capsule size and internal composition). Generally, compositions according to the present disclosure may be used according to any suitable purpose known in the art that facilitates the compositions described herein.

In some embodiments, described herein is a method for controlling a pest comprising contacting the pest or its environment with a biologically effective amount of a composition comprising: an antifreeze agent; and a microcapsule comprising: a core comprising: a pheromone; and a solvent; and a shell encapsulating the core; wherein the microcapsule has a d90 value of at least about 30 μm.

Compositions of this disclosure are useful for controlling a wide spectrum of invertebrate pests. These pests include invertebrates inhabiting a variety of environments such as, for example, plant foliage, roots, soil, harvested crops or other foodstuffs, building structures or animal integuments. These pests include, for example, invertebrates feeding on foliage (including leaves, stems, flowers and fruits), seeds, wood, textile fibers or animal blood or tissues, and thereby causing injury or damage to, for example, growing or stored agronomic crops, forests, greenhouse crops, ornamentals, nursery crops, stored foodstuffs or fiber products, or houses or other structures or their contents, or being harmful to animal health or public health. Those skilled in the art will appreciate that not all compositions are equally effective against all growth stages of all pests.

These present compositions are thus useful agronomically for protecting field crops from phytophagous invertebrate pests, and also nonagronomically for protecting other horticultural crops and plants from phytophagous invertebrate pests. This utility includes protecting crops and other plants (i.e. both agronomic and nonagronomic) that contain genetic material introduced by genetic engineering (i.e. transgenic) or modified by mutagenesis to provide advantageous traits. Examples of such traits include tolerance to herbicides, resistance to phytophagous pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits. Examples of plants containing traits provided by genetic engineering or mutagenesis include varieties of corn, cotton, soybean and potato expressing an insecticidal Bacillus thuringiensis toxin such as YIELD GARD®, KNOCKOUT®, STARLINK®, BOLLGARD®, NuCOTN® and NEWLEAF®, INVICTA RR2 PRO™, and herbicide-tolerant varieties of corn, cotton, soybean and rapeseed such as ROUNDUP READY®, LIBERTY LINK®, IMI®, STS® and CLEARFIELD®, as well as crops expressing N-acetyltransferase (GAT) to provide resistance to glyphosate herbicide, or crops containing the HRA gene providing resistance to herbicides inhibiting acetolactate synthase (ALS). The present compositions may exhibit enhanced effects with traits introduced by genetic engineering or modified by mutagenesis, thus enhancing phenotypic expression or effectiveness of the traits or increasing the invertebrate pest control effectiveness of the present compounds and compositions. In particular, the present compositions may exhibit enhanced effects with the phenotypic expression of proteins or other natural products toxic to invertebrate pests to provide greater-than-additive control of these pests.

Compositions of this disclosure can also optionally comprise plant nutrients, e.g., a fertilizer composition comprising at least one plant nutrient selected from nitrogen, phosphorus, potassium, sulfur, calcium, magnesium, iron, copper, boron, manganese, zinc, and molybdenum. Of note are compositions comprising at least one fertilizer composition comprising at least one plant nutrient selected from nitrogen, phosphorus, potassium, sulfur, calcium and magnesium. Compositions of the present disclosure which further comprise at least one plant nutrient can be in the form of liquids or solids. Of note are solid formulations in the form of granules, small sticks or tablets. Solid formulations comprising a fertilizer composition can be prepared by mixing the composition of the present disclosure with the fertilizer composition together with formulating ingredients and then preparing the formulation by methods such as granulation or extrusion. Alternatively solid formulations can be prepared by spraying a solution or suspension of a composition of the present disclosure in a volatile solvent onto a previous prepared fertilizer composition in the form of dimensionally stable mixtures, e.g., granules, small sticks or tablets, and then evaporating the solvent.

Nonagronomic uses refer to invertebrate pest control in the areas other than fields of crop plants. Nonagronomic uses of the present compositions include control of invertebrate pests in stored grains, beans and other foodstuffs, and in textiles such as clothing and carpets. Nonagronomic uses of the present compositions also include invertebrate pest control in ornamental plants, forests, in yards, along roadsides and railroad rights of way, and on turf such as lawns, golf courses and pastures. Nonagronomic uses of the present compositions also include invertebrate pest control in houses and other buildings which may be occupied by humans and/or companion, farm, ranch, zoo or other animals. Nonagronomic uses of the present compositions also include the control of pests such as termites that can damage wood or other structural materials used in buildings.

Nonagronomic uses of the present compositions also include protecting human and animal health by controlling invertebrate pests that are parasitic or transmit infectious diseases. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. Compositions of the present disclosure are suitable for systemic and/or non-systemic control of infestation or infection by parasites on animals. Compositions of the present disclosure are suitable for combating external parasitic or disease transmitting pests. Compositions of the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. By combating these parasites, fatalities and performance reduction (in terms of meat, milk, wool, skins, eggs, honey, etc.) are reduced, so that applying a composition of the present disclosure allows more economic and simple husbandry of animals.

Examples of agronomic or nonagronomic invertebrate pests include eggs, larvae and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), beet armyworm (Spodoptera exigua Hübner), cotton leafworm (Spodoptera littoralis Boisduval), yellowstriped armyworm (Spodoptera ornithogalli Guenée), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworms (Pyralidae: Crambinae) such as sod worm (Herpetogramma licarsisalis Walker), sugarcane stem borer (Chilo infuscatellus Snellen), tomato small borer (Neoleucinodes elegantalis Guenée), green leafroller (Cnaphalocrocis medinalis Guenée), grape leaffolder (Desmia funeralis Hübner), pickleworm (Diaphania nitidalis Stoll), cabbage center grub (Hellula hydralis Guenée), yellow stem borer (Scirpophaga incertulas Walker), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis Zeller)); leafrollers, budworms, seed worms, and fruit worms in the family Tortricidae (e.g., codling moth (Cydia pomonella Linnaeus), grape berry moth (Paralobesia viteana Clemens), oriental fruit moth (Grapholita molesta Busck), citrus false codling moth (Cryptophlebia leucotreta Meyrick), citrus borer (Gymnandrosoma aurantianum Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamondback moth (Plutella xylostella Linnaeus), pink bollworm (Pectinophora gossypiella Saunders), gypsy moth (Lymantria dispar Linnaeus), peach fruit borer (Carposina niponensis Walsingham), peach twig borer (Anarsia lineatella Zeller), potato tuberworm (Phthorimaea operculella Zeller), spotted teniform leafminer (Phyllonorycter blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Serville), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus Chittenden), Rocky Mountain billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scarabaeidae (e.g., Japanese beetle (Popillia japonica Newman), oriental beetle (Anomala orientalis Waterhouse, northern masked chafer (Cyclocephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae and flour beetles from the family Tenebrionidae.

In addition, agronomic and nonagronomic pests include: eggs, adults and larvae of the order Dermaptera including earwigs from the family Forficulidae (e.g., European earwig (Forficula auricularia Linnaeus), black earwig (Chelisoches morio Fabricius)); eggs, immatures, adults and nymphs of the order Hemiptera such as, plant bugs from the family Miridae, cicadas from the family Cicadidae, leafhoppers (e.g. Empoasca spp.) from the family Cicadellidae, bed bugs (e.g., Cimex lectularius Linnaeus) from the family Cimicidae, planthoppers from the families Fulgoridae and Delphacidae, treehoppers from the family Membracidae, psyllids from the families Liviidae, Psyllidae, and Triozidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, chinch bugs (e.g., hairy chinch bug (Blissus leucopterus hirtus Montandon) and southern chinch bug (Blissus insularis Barber)) and other seed bugs from the family Lygaeidae, spittlebugs from the family Cercopidae squash bugs from the family Coreidae, and red bugs and cotton stainers from the family Pyrrhocoridae.

Agronomic and nonagronomic pests also include: eggs, larvae, nymphs and adults of the order Acari (mites) such as spider mites and red mites in the family Tetranychidae (e.g., European red mite (Panonychus ulmi Koch), twospotted spider mite (Tetranychus urticae Koch), McDaniel spider mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodecidae, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and ticks in the family Argasidae, commonly known as soft ticks (e.g., relapsing fever tick (Ornithodoros turicata Duges), common fowl tick (Argas radiatus Raillet)); scab and itch mites in the families Psoroptidae, Pyemotidae, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forsskäl), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borellii Giglio-Tos)); eggs, adults and immatures of the order Diptera including leafminers (e.g., Liriomyza spp, such as serpentine vegetable leafminer (Liriomyza sativae Blanchard)), midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gasterophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera: eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes F. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the orders Mallophaga and Phthiraptera, and including the head louse (Pediculus humanus capitis De Geer), body louse (Pediculus humanus Linnaeus), chicken body louse (Menacanthus stramineus Nitzsch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouché), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus Horn), lesser grain borer (Rhyzopertha dominica Fabricius), rice weevil (Sitophilus oryzae Linnaeus), maize weevil (Sitophilus zeamais Motschulsky), cowpea weevil (Callosobruchus maculatus Fabricius), red flour beetle (Tribolium castaneum Herbst), granary weevil (Sitophilus granarius Linnaeus), Indian meal moth (Plodia interpunctella Hübner), Mediterranean flour beetle (Ephestia kuehniella Zeller) and flat or rusty grain beetle (Cryptolestes ferrugineus Stephens).

Compositions of the present disclosure may be useful to control members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compositions of the disclosure may be useful to control pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrocis medinalis Guenée (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (Old World bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)).

Compositions of the disclosure may be useful to control members from the order Hemiptera including: Acyrthosiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Passerini (rosy apple aphid), Eriosoma lanigerum Hausmann (woolly apple aphid), Hyalopterus pruni Geoffroy (mealy plum aphid), Lipaphis pseudobrassicae Davis (turnip aphid), Metopolophium dirrhodum Walker (rose-grain aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricidus Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrosteles quadrilineatus Forbes (aster leafhopper), Nephotettix cincticeps Uhler (green rice leafhopper), Nephotettix nigropictus Stål (rice leafhopper), Nilaparvata lugens Stål (brown planthopper), Peregrinus maidis Ashmead (corn planthopper), Sogatella furcifera Horváth (white-backed planthopper), Tagosodes orizicolus Muir (rice delphacid), Typhlocyba pomaria McAtee (white apple leafhopper), Erythroneura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions of this disclosure may be useful to control members from the order Hemiptera including: Acrosternum hilare Say (green stink bug), Anasa tristis De Geer (squash bug), Blissus leucopterus leucopterus Say (chinch bug), Cimex lectularius Linnaeus (bed bug) Corythucha gossypii Fabricius (cotton lace bug), Cyrtopeltis modesta Distant (tomato bug), Dysdercus suturellus Herrich-Schäffer (cotton stainer), Euschistus servus Say (brown stink bug), Euschistus variolarius Palisot de Beauvois (one-spotted stink bug), Graptostethus spp. (complex of seed bugs), Halyomorpha halys Stål (brown marmorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compositions of the disclosure include Thysanoptera (e.g., Frankliniella occidentalis Pergande (western flower thrips), Scirtothrips citri Moulton (citrus thrips), Scirtothrips variabilis Beach (soybean thrips), and Thrips tabaci Lindeman (onion thrips); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

In some embodiments, the pest is selected from the group consisting of invertebrate pests, insects, arthropods, and combinations thereof.

In some embodiments, the environment is selected from the group consisting of agricultural fields, orchards, forests, and combinations thereof.

The composition embodiments of this disclosure may be combined with the method embodiments of this disclosure in any manner. Similarly, the method embodiments of this disclosure may be combined in any manner. The following embodiments are, therefore, to be construed as merely illustrative, and not limiting of the disclosure in any way whatsoever.

Aspects of the present disclosure are provided by the subject matter of the following clauses:
1. A composition comprising:
   an antifreeze agent; and
   a microcapsule comprising:
a core comprising:
   a pheromone; and
   a solvent; and
a shell encapsulating the core;
   wherein the microcapsule has a d90 value of at least about 30 μm.
2. The composition in accordance with the preceding clause, wherein the microcapsule has a d90 value in a range of from about 30 μm to about 60 μm.
3. The composition in accordance with any preceding clause, wherein the microcapsule has a d90 value in a range of from about 35 μm to about 50 μm.
4. The composition in accordance with any preceding clause, wherein the microcapsule has a d50 value in a range of from about 5 μm to about 25 μm.
5. The composition in accordance with any preceding clause, wherein the microcapsule has a d10 value in a range of from about 1 μm to about 7 μm.
6. The composition in accordance with any preceding clause, wherein the composition further comprises an auxiliary selected from dispersants, surfactants, emulsifiers, wetting agents, biocides, antifoamers, antifreeze agents, rheology modifiers, solvents, stabilizers, UV stabilizers, UV absorbers, salts, excipients, antioxidants, and combinations thereof.
7. The composition in accordance with any preceding clause, wherein the composition is an agrochemical composition.
8. The composition in accordance with any preceding clause, wherein the composition is in a form selected from a premix and a tank mix.
9. The composition in accordance with any preceding clause, wherein the composition is in a form of a CS formulation or a ZC formulation.
10. The composition in accordance with any preceding clause, wherein the shell comprises a material selected from synthetic polymers, polyureas, polyurethanes, polyacrylates, polyamides, polyvinyl alcohols, polyvinylpyrrolidones, polycarbonates, polythiocarbonates, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.
11. The composition in accordance with any preceding clause, wherein the pheromone is selected from aldehyde pheromones, acetate pheromones, alcohol pheromones, ketone pheromones, epoxide pheromones, hydrocarbon pheromones, ester pheromones, and combinations thereof.
12. The composition in accordance with any preceding clause, wherein the pheromone does not comprise an aldehyde pheromone.
13. The composition in accordance with any preceding clause, wherein the pheromone is selected from (Z)-5-decenyl acetate, dodecanyl acetate, (Z)-7-dodecenyl acetate, (E)-7-dodecenyl acetate, (Z)-8-dodecenyl acetate, (E)-8-dodecenyl acetate, (Z)-9-dodecenyl acetate, (E)-9-dodecenyl acetate, (E)-10-dodecenyl acetate, 11-dodecenyl acetate, (Z)-9,11-dodecadienyl acetate, (E)-9,11-dodecadienyl acetate, (Z)-11-tridecenyl acetate, (E)-11-tridecenyl acetate, tetradecanyl acetate, (E)-7-tetradecenyl acetate, (Z)-8-tetradecenyl acetate, (E)-8-tetradecenyl acetate, (Z)-9-tetradecenyl acetate, (E)-9-tetradecenyl acetate, (Z)-10-tetradecenyl acetate, (E)-10-tetradecenyl acetate, (Z)-11-tetradecenyl acetate, (E)-11-tetradecenyl acetate, (Z)-12-pentadecenyl acetate, (E)-12-pentadecenyl acetate, hexadecanyl acetate, (Z)-7-hexadecenyl acetate, (Z)-11-hexadecenyl acetate, (E)-11-hexadecenyl acetate, octadecanyl acetate, (E,Z)-7,9-dodecadienyl acetate, (Z,E)-7,9-dodecadienyl acetate, (E,E)-7,9-dodecadienyl acetate, (Z,Z)-7,9-dodecadienyl acetate, (E,E)-8,10-dodecadienyl acetate, (E,Z)-9,12-dodecadienyl acetate, (E,Z)-4,7-tridecadienyl acetate, (E,E)-9,11-tetradecadienyl acetate, (Z,Z)-9,12-tetradecadienyl acetate, (Z,Z)-7,11-hexadecadienyl acetate, (E,Z)-7,11-hexadecadienyl acetate, (Z,E)-7,11-hexadecadienyl acetate, (E,E)-7,11-hexadecadienyl acetate, (Z,E)-3,13-octadecadienyl acetate, (E,Z)-3,13-octadecadienyl acetate, (E,E)-3,13-octadecadienyl acetate, (Z)-5-decenyl 3-methylbutanoate, (+) cis-7,8-epoxy-2-methyloctadecane, methyl (E,Z)-2,4-decadienoate, methyl 2,6,10-trimethyltridecanoate, and combinations thereof.
14. The composition in accordance with any preceding clause, wherein the antifreeze agent is selected from propylene glycol, glycerin, glycols, ethylene glycol, 1,2-butane diol, 1,3-butane diol, 2,3-butanediol, 1,4-butanediol, methanol, ethanol, propanol, butanol, and combinations thereof.
15. The composition in accordance with any preceding clause, wherein the solvent is selected from hydrophobic solvents, high flashpoint-type solvents, methylated seed oils, methyl oleate methyl ester oil, methyl linoleate methyl ester oil, mineral oils, paraffinic oils, tall oil fatty acid-based solvents, aromatic solvents, aromatic ester solvents, polybutenes, methyl esters of fatty acids, tributyl 2-acetate citrate, alkylamide solvents, benzyl acetate, wax esters, and combinations thereof.
16. A method of making a composition, the method comprising:
   forming a mixture comprising:
      an antifreeze agent; and
      a microcapsule comprising:
      a core comprising:
         a pheromone; and
         a solvent; and
         a shell encapsulating the core;
      wherein the microcapsule has a d90 value of at least about 30 μm.
17. The method in accordance with the preceding clause, wherein the method further comprises encapsulating the pheromone and the solvent in the microcapsule prior to forming the mixture.
18. A method for controlling a pest comprising contacting the pest or its environment with a biologically effective amount of a composition comprising:
   an antifreeze agent; and
   a microcapsule comprising:
a core comprising:
   a pheromone; and
   a solvent; and
   a shell encapsulating the core;
wherein the microcapsule has a d90 value of at least about 30 μm.
19. The method in accordance with the preceding clause, wherein the pest is selected from invertebrate pests, insects, arthropods, and combinations thereof.
20. The method in accordance with any preceding clause, wherein the environment is selected from agricultural fields, orchards, forests, and combinations thereof.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES

### Example 1. Solvent Screen

Solvents with different chemistries were used to prepare emulsion-in-water (EW) formulations containing Z9-14 acetate pheromone. A control, a solvent-free EW formulation, was also prepared and evaluated. Table 1 summarizes the volatility and chemical stability of the EW formulations and the results were sorted to list the best performing sample last according to the best volatility control. An EW formulation using Steposol ME (a methyl oleate/methyl linoleate methyl ester oil from Stepan) outperformed other EW formulations in this series. Formulations not including a solvent exhibited the worst performance.

To measure the chemical stability, EW formulations were placed inside tightly sealed scintillation vials and then the vials were placed in an oven heated to 60° C. for 4 hours. The remaining Z9-14 acetate pheromone in each vial was quantified. Because the scintillation vials were tightly sealed, the loss of Z9-14 acetate pheromone was associated with chemical degradation. Chemical stability was measured as the remaining wt. % of Z9-14 acetate pheromone.

To measure the volatility, EW formulations were placed in uncapped vials and then the vials were placed in an oven and heated to 60° C. for 4 hours. The remaining Z9-14 acetate pheromone in each vial was quantified. Because the scintillation vials were uncapped, the Z9-14 acetate pheromone was able to evaporate. Volatility was measured as the remaining wt. % of Z9-14 acetate pheromone.

TABLE 1
Chemical stability and volatility for EW formulations
containing Z9-14 acetate pheromone.

| | | | Chemical |
|---|---|---|---|
| | | Volatility | Stability |
| Solvent | Chemical name of the solvent | (wt %) | (wt %) |
| None | None | 7 | 79 |
| SurfonicAG1705 | benzyl acetate | 21 | 79 |
| Halicomid M-10 | N,N-dimethyldecanamide | 24 | 89 |
| Tributyl 2-acetate | tributyl 2-acetate citrate | 26 | 99 |
| citrate | | | |
| Steposol C1218 | methyl | 29 | 89 |
| | laurate/myristate/palmitate/ | | |
| | oleate methyl ester | | |
| Indopol H7 | liquid polybutene polymer | 29 | 82 |
| | (low MW) | | |
| Jeffsol AG1700 | butyl benzoate | 32 | 75 |
| Altapyne M-28B | distilled tall oil (DTO), | 33 | 95 |
| | containing fatty acids and | | |
| | 28% rosin | | |
| Parol 6970 LP | white mineral oil (mixture | 34 | 97 |
| | of higher alkanes) | | |
| Steposol ME | methyl oleate/methyl | 40 | 98 |
| | linoleate | | |

### Example 2. Volatility Control of Microencapsulated Z9-14 Acetate Formulations

Encapsulation of the pheromone was achieved by reacting isocyanate and amine to create a polymer wall that shields the pheromone and solvent from contact with the environment. In a stirring vessel, a solution of a hydrophobic monomer (isocyanate compound), a solvent, and a pheromone were emulsified in water. The size of the droplets obtained was regulated by the speed of the stirrer. The water-soluble monomer was then introduced into the stirred tank and formed a polymer by chemical polymerization reactions. The slurry was then allowed to mix at a lower speed for several hours at 50-60° C. to achieve complete reaction for the monomers. The finishing operations were then carried out. The finishing operations include adjusting the acidity of the medium and adding post formulants (biocides, rheology modifiers, and antifreeze compounds) to yield a final formulation.

The below table provides volatility control data for CS formulations of Z9-14 acetate where the varied parameter is the solvent. The solvents evaluated included: Steposol ME (methyl Oleate/Methyl linoleate from Stepan), Hallcomid M-10 (N,N-dimethyldecanamide from Stepan), Surfonic AG 1705 (Benzyl acetate from Indorama), Tributyl 2-acetate citrate (from Sigma Millipore), Stepan C42 (Methyl laurate/methyl myristate from Stepan), Stepan C65 (Methyl palmitate/Oleate-Stearate from Stepan), and Sunspray N11 (Paraffinic oil from HollyFrontier Specialty Products). Steposol ME has a vapor pressure of 3.12 mm Hg at 20° C., Stepan C25 has a vapor pressure of 0.36 mm Hg at 20° C., Stepan C42 has a vapor pressure of 0.0163 mm Hg at 25° C., and Stepan C65 has a vapor pressure of 0.01 mm Hg at 20° C.

It was surprisingly found that Steposol ME achieves the best volatility control for the pheromone despite possessing the highest vapor pressure of the tested solvents. Sunspray N11 also give good volatility control while Stepan C42 was not effective in this system.

TABLE 2
Volatility control of microencapsulated Z9-14 acetate formulations.

| | A-1 | A-2 | A-3 | A-4 | A-5 | A-6 |
|---|---|---|---|---|---|---|
| Ingredient | Wt % | Wt % | Wt % | Wt % | Wt % | Wt % |
| Z-9-14Ac | 20.5 | 20.5 | 20.5 | 20.5 | 20.5 | 20.5 |
| Steposol ME | 6.0 | | | | | |
| Surfonic AG 1705 | | 6.0 | | | | |
| Tributyl 2-acetate citrate | | | 6.0 | | | |
| Stepan C65 | | | | 6.0 | | |
| Sunspray N11 | | | | | 6.0 | |
| Stepan C42 | | | | | | 6.0 |
| Reax 88B | 0.8 | 0.8 | 0.8 | 0.8 | 0.8 | 0.8 |
| Papi 27 | 3.4 | 3.4 | 3.4 | 3.4 | 3.4 | 3.4 |
| HDMA | 1.46 | 1.46 | 1.46 | 1.46 | 1.46 | 1.46 |
| Other ingredients (e.g., water, | To | To | To | To | To | To |
| pH Buffer, xanthan gum, | 100% | 100% | 100% | 100% | 100% | 100% |
| biocide) | | | | | | |
| Particle size (DV10), μm | 7.0 | 9.76 | 6.04 | 2.92 | 6.43 | 8.23 |
| Particle size (DV50), μm | 21.78 | 27.22 | 24.53 | 19.62 | 24.59 | 26.57 |
| Particle size (DV90), μm | 38.2 | 42.71 | 41.05 | 40.96 | 43.9 | 45.13 |
| Volatility control at 48 hours | 52 | 25 | 24 | 48 | 60 | 7 |
| of simulated sunlight (wt %) | | | | | | |

Volatility control for the pheromone in a CS formulation was measured as follows. In the photolysis PEACH Drop Method, aqueous spray solutions of formulated material were applied as droplets on glass. After desired time periods passed in a solar simulating light (0-99 hours), the glass was extracted in a solvent. The extract was analyzed by GC for amount of pheromone remaining on the glass. T24 hr, T44 hr, T46 hr, and T99 hr represent 24 hours, 44 hours, 46 hours, and 99 hours, respectively, in a solar simulating light chamber with continuous light on. Each 24 hours of solar simulating light is equivalent to 2.5 days of sunlight.

It was surprisingly discovered herein that the highest volatility control was achieved for capsules with a d90 of about 40 μm, where the capsules also include the antifreeze and the solvent. The antifreeze was added in a final step, after the completion of the cook process, to improve the handling characteristics of the formulation in cold temperatures. The antifreeze lowers the freezing point of water by disrupting the formation of ice crystals in the continuous phase. However, the observed added benefit that propylene glycol also improves the volatility control of the pheromone was unexpected.

Factors observed to negatively impact control for the pheromone include smaller particle sizes of the capsules, absence of the solvent, and absence of the antifreeze. Therefore, the combination of the particle size, antifreeze, and solvent provides significant benefits.

### Example 3. Effect of Antifreeze

The effect of antifreeze compound (propylene glycol) was also evaluated. The loading level of the Z-9-tetradecenyl acetate pheromone was set at 15 wt. % in B-1 and B-2, and at 21 wt. % in B-3 and B-4. The particle size of the microcapsules was kept constant at 37 μm. The data surprisingly showed that propylene glycol improves the volatility control of the pheromone compound.

TABLE 3
Effect of antifreeze.

| | B-1 | B-2 | B-3 | B-4 |
|---|---|---|---|---|
| Ingredient | Wt % | Wt % | Wt % | Wt % |
| Z-9-tetradecenyl acetate | 15.4 | 15.4 | 20.5 | 20.5 |
| Steposol ME | 4.5 | 4.5 | 6.0 | 6.0 |
| Reax 88B | 0.8 | 0.8 | 1.1 | 1.1 |
| Papi 27 | 2.5 | 2.5 | 3.4 | 3.4 |
| HDMA | 1.07 | 1.07 | 1.41 | 1.41 |
| Propylene glycol | 5.0 | 0.0 | 4.5 | 0.0 |
| Rhodopol 23 | 0.16 | 0.16 | 0.16 | 0.16 |
| Acticide SPX | 0.16 | 0.16 | 0.16 | 0.16 |
| Acetic acid | 1.0 | 1.0 | 1.2 | 1.2 |
| Other ingredients (e.g., water, pH | To | To | To | To |
| Buffer, xanthan gum, biocide) | 100% | 100% | 100% | 100% |
| Total | 100.00 | 100.00 | 100.00 | 100.00 |
| Particle size (DV10), μm | 3.92 | 3.86 | 3.38 | 3.36 |
| Particle size (DV50), μm | 21.22 | 21.14 | 20.31 | 20.34 |
| Particle size (DV90), μm | 36.6 | 36.42 | 35.66 | 35.76 |
| Volatility control at 46 hours of | 53 | 38 | 45 | 39 |
| simulated sunlight (wt %) | | | | |
| Volatility control at 99 hours of | 3.7 | 0.8 | 1.5 | 0.3 |
| simulated sunlight (wt %) | | | | |

### Example 4. Effect of Antifreeze

The effect of two antifreeze compounds, glycerin and propylene glycol, was tested and compared in a microencapsulated formulation containing Z-9-tetradecenyl acetate pheromone. The particle size of the microcapsules was kept constant at 27 μm. The data show that both antifreeze compounds improve the volatility control for the pheromone. Propylene glycol is more effective compared to glycerin at a same loading level.

TABLE 4
Effect of antifreeze.

| | C-1 | C-2 | C-3 | C-4 | C-5 |
|---|---|---|---|---|---|
| Ingredient | Wt % | Wt % | Wt % | Wt % | Wt % |
| Z-9-tetradecenyl acetate | 20.5 | 20.5 | 20.5 | 20.5 | 20.5 |
| Steposol MB | 6.0 | 6.0 | 6.0 | 6.0 | 6.0 |
| Reax 88B | 1.1 | 1.1 | 1.1 | 1.1 | 1.1 |
| Papi 27 | 3.4 | 3.4 | 3.4 | 3.4 | 3.4 |
| Hexametylene diamine | 1.46 | 1.46 | 1.46 | 1.46 | 1.46 |
| Propylene glycol | 0.0 | 5.0 | 10.0 | 0.0 | 0.0 |
| Glycerin | 0.0 | 0.0 | 0.0 | 5.0 | 10.0 |
| Rhodopol 23 | 0.12 | 0.12 | 0.12 | 0.12 | 0.12 |
| Acticide SPX | 0.12 | 0.12 | 0.12 | 0.12 | 0.12 |
| Acetic acid | 1.2 | 1.2 | 1.2 | 1.2 | 1.2 |
| Other ingredients (e.g., water, pH | To | To | To | To | To |
| Buffer, xanthan gum, biocide) | 100% | 100% | 100% | 100% | 100% |
| Total | 100.00 | 100.00 | 100.00 | 100.00 | 100.00 |
| Particle size (DV10), μm | 2.94 | 2.96 | 2.95 | 2.96 | 2.95 |
| Particle size (DV50), μm | 15.67 | 15.82 | 15.7 | 15.7 | 15.68 |
| Particle size (DV90), μm | 26.76 | 26.91 | 26.79 | 26.69 | 26.74 |
| Volatility control at 48 hours of | 12 | 23 | 31 | 16 | 20 |
| simulated sunlight (wt %) | | | | | |

### Example 5. Effect of Particle Size of the Microcapsules, the Solvent, and the Antifreeze

The effect of the particle size of the microcapsules, the solvent, and the antifreeze was evaluated. As shown in the table below, a decrease in particle size for the microcapsules resulted in a decrease in volatility control for the pheromone. In addition, a removal of the solvent and/or antifreeze compound resulted in a decrease in volatility control (i.e., more pheromone was lost).

TABLE 5
Effect of particle size of the microcapsules,
the solvent, and the antifreeze.

| | D-1 | D-2 | D-3 | D-4 | D-5 | D-6 | D-7 |
|---|---|---|---|---|---|---|---|
| Ingredient | Wt % | Wt % | Wt % | Wt % | Wt % | Wt % | Wt % |
| Z-9-tetradecenyl | 15.05 | 15.05 | 15.05 | 15.05 | 15.05 | 15.05 | 15.05 |
| acetate pheromone | | | | | | | |
| Steposol ME | 5.0 | 5.0 | 5.0 | 5.0 | 5.0 | 0.0 | 0.0 |
| Reax 88B | 0.8 | 0.8 | 0.8 | 0.8 | 0.8 | 0.8 | 0.8 |
| Papi 27 | 2.8 | 2.8 | 2.8 | 2.8 | 2.8 | 2.8 | 2.8 |
| Hexamethylene | 1.19 | 1.19 | 1.19 | 1.19 | 1.19 | 1.19 | 1.19 |
| diamine | | | | | | | |
| Propylene glycol | 5.0 | 5.0 | 0.0 | 0.0 | 0.0 | 0.0 | 0.0 |
| Rhodopol 23 | 0.16 | 0.16 | 0.16 | 0.16 | 0.16 | 0.16 | 0.16 |
| Proxel GXL | 0.16 | 0.16 | 0.16 | 0.16 | 0.16 | 0.16 | 0.16 |
| Acetic acid | 0.5 | 0.5 | 0.5 | 0.5 | 0.5 | 0.5 | 0.5 |
| Other ingredients (e.g., | To | To | To | To | To | To | To |
| water, pH Buffer, | 100% | 100% | 100% | 100% | 100% | 100% | 100% |
| xanthan gum, biocide) | | | | | | | |
| Particle size (DV10), | 6.12 | 2.34 | 6.07 | 4.09 | 2.29 | 6.01 | 2.43 |
| μm | | | | | | | |
| Particle size (DV50), | 23.85 | 12.78 | 25.1 | 19.56 | 13.69 | 24.22 | 11.78 |
| μm | | | | | | | |
| Particle size (DV90), | 41.08 | 21.3 | 42.64 | 33.06 | 20.2 | 41.83 | 22.5 |
| μm | | | | | | | |
| Volatility control at 24 | 79 | 42 | 64 | 45 | 53 | 53 | 44 |
| hours of simulated | | | | | | | |
| sunlight (wt %) | | | | | | | |
| Volatility control at 48 | 35 | 10 | 30 | 14 | 19 | 21 | 3 |
| hours of simulated | | | | | | | |
| sunlight (wt %) | | | | | | | |

### Example 6. Encapsulation of Z-9-Tetradecenyl Acetate

Microencapsulation of Z-9-tetradecenyl acetate pheromone including Suprasec 5025 (a polymeric diphenyl methane diisocyanate (MDI)) as an isocyanate and Hallcomid M-10 as a solvent was evaluated.

As shown in the table below, a decrease in particle size for the microcapsules resulted in a decrease in volatility control for the pheromone.

TABLE 6
Capsule suspension formulations using
Suprasec 5025 as the isocyanate.

| | E-1 | E-2 |
|---|---|---|
| Ingredient | Wt % | Wt % |
| Z-9-tetradecenyl acetate | 20.5 | 20.5 |
| Hallcomid M-10 | 6.0 | 6.0 |
| Reax 88B | 1.1 | 1.1 |
| Suprasec 5025 | 3.4 | 3.4 |
| Hexamethylene diamine | 1.46 | 1.46 |
| Propylene glycol | 4.5 | 4.5 |
| Rhodopol 23 | 0.12 | 0.12 |
| Acticide SPX | 0.12 | 0.12 |
| Acetic acid | 0.1 | 0.1 |
| Water | Rest | Rest |
| Total | 100.00 | 100.00 |
| Particle size (DV10), μm | 3.77 | 6.56 |
| Particle size (DV50), μm | 17.28 | 21.59 |
| Particle size (DV90), μm | 33.89 | 42.45 |
| Volatility control at 40 hours of | 53 | 63 |
| simulated sunlight (wt %) | | |

### Example 7. Encapsulation of Z-11-Hexadecenyl Acetate Using EDA Amine and PAPI 27

The use of ethylenediamine (EDA) as an amine crosslinker was evaluated similar to the above examples where hexamethylene diamine (HMDA) was used.

As shown in the table below, a decrease in particle size for the microcapsules resulted in a decrease in volatility control for the pheromone.

TABLE 7
Capsule suspension formulations using EDA as the amine.

| | F-1 | F-2 |
|---|---|---|
| Ingredient | Wt % | Wt % |
| Z-11-hexadecenyl acetate | 18.5 | 18.5 |
| Steposol ME | 5.0 | 5.0 |
| Hallcomid M-10 | 1.0 | 1.0 |
| Reax 88B | 0.8 | 0.8 |
| PAPI27 | 1.5 | 1.5 |
| Ethylene Diamine | 0.34 | 0.34 |
| Propylene glycol | 4.0 | 4.0 |
| Rhodopol 23 | 0.12 | 0.12 |
| Acticide SPX | 0.12 | 0.12 |
| Acetic acid | 0.25 | 0.25 |
| Toximul 8320 | 1.0 | 1.0 |
| Step-flow 4000 | 0.5 | 0.5 |
| Water | Rest | Rest |
| Particle size (DV10), μm | 2.24 | 7.17 |
| Particle size (DV50), μm | 11.91 | 23.90 |
| Particle size (DV90), μm | 20.68 | 41.44 |
| Volatility control at 40 hours of | 39 | 59 |
| simulated sunlight (wt %) | | |

### Example 8. Encapsulation of Z-9-Tetradecenyl Acetate Using EDA Amine and Takenate Isocyanates

The use of ethylenediamine (EDA) as an amine crosslinker in combination with Takenate™M500 (m-xylylene diisocyanates (XDI)) and Takenate™ D-110N (a trimethylol propane-adduct of xylylene diisocyanate) was evaluated similar to the above examples where hexamethylene diamine (HMDA) was used.

As shown in the table below, a decrease in particle size for the microcapsules resulted in a decrease in volatility control for the pheromone.

TABLE 8
Capsule suspension formulations using EDA as the amine.

| | G-1 | G-2 | G-3 | G-4 |
|---|---|---|---|---|
| Ingredient | Wt % | Wt % | Wt % | Wt % |
| Z-9-Tetradecenyl acetate | 20.5 | 20.5 | 20.5 | 20.5 |
| Steposol ME | | | 2.0 | 2.0 |
| Hallcomid M-10 | 6.0 | 6.0 | 4.0 | 4.0 |
| Reax 88B | 1.1 | 1.1 | 1.1 | 1.1 |
| Takenate ™ 500 | 0.26 | 0.53 | 0.54 | 0.54 |
| Takenate ™ D-110N | 2.38 | 4.76 | 4.86 | 4.86 |
| Ethylene Diamine | 0.28 | 0.56 | 0.56 | 0.56 |
| Propylene glycol | 4.50 | 4.50 | 4.50 | 4.50 |
| Rhodopol 23 | 0.16 | 0.16 | 0.16 | 0.16 |
| Acticide SPX | 0.16 | 0.16 | 0.16 | 0.16 |
| Acetic acid | 0.20 | 0.20 | 0.20 | 0.20 |
| Water | To 100% | To 100% | To 100% | To 100% |
| Particle size (DV10), μm | 1.8 | 3.9 | 3.74 | 6.8 |
| Particle size (DV50), μm | 10.0 | 18.3 | 17.9 | 24.6 |
| Particle size (DV90), μm | 17.7 | 31.3 | 30.2 | 41.7 |
| Volatility control at 40 hours of | Accept- | Accept- | Accept- | Accept- |
| simulated sunlight (wt %) | able | able | able | able |

### Example 9. Encapsulated Z-11-Hexadecenyl Acetate Pheromone

Z-11-hexadecenyl acetate pheromone was used to prepare a microencapsulated formulation. The effect of particle size of the microcapsules, the solvent, and the antifreeze was evaluated. The control formulations without antifreeze included water to replace the antifreeze. As shown in the table below, the volatility data revealed that the incorporation of the antifreeze improves the volatility control of the pheromone. In addition, like in the formulations including Z-9-tetradecenyl acetate pheromone, this example confirmed that a decrease in particle size for the microcapsules resulted in a decrease in volatility control for the pheromone.

TABLE 9
Encapsulated Z-11-hexadecenyl acetate pheromone.

| | H-1 | H-2 |
|---|---|---|
| Ingredient | Wt % | Wt % |
| Z-11-hexadecenyl acetate | 20.5 | 20.5 |
| Steposol ME | 5 | 5 |
| Butylated hydroxytoluene | 1 | 1 |
| Reax 88B | 0.8 | 0.8 |
| PAPI27 | 3.3 | 3.3 |
| HDMA | 1.4 | 1.4 |
| Propylene glycol | 4 | 4 |
| Rhodopol 23 | 0.08 | 0.08 |
| Acticide SPX | 0.08 | 0.08 |
| Acetic acid | 0.2 | 0.2 |
| Other ingredients (e.g., water, pH | To | To |
| Buffer, xanthan gum, biocide) | 100% | 100% |
| Total | 100.00 | 100.00 |
| Particle size (DV10), μm | 2.37 | 6.99 |
| Particle size (DV50), μm | 13.01 | 24.75 |
| Particle size (DV90), μm | 22.19 | 42.65 |
| Volatility control at 48 hours of | 34 | 52 |
| simulated sunlight (wt %) | | |

### Example 10. Pheromone Concentration

The volatility control data for formulations using two different concentrations of the pheromones (150 g/L and 200 g/L) was evaluated. As shown in the table below, the best volatility control of the Z9-14 acetate pheromone was achieved with the D90 particle size of the capsule of about 40 μm.

TABLE 10
Pheromone concentration.

| | I-1 | I-2 | I-3 | I-4 |
|---|---|---|---|---|
| Ingredient | Wt % | Wt % | Wt % | Wt % |
| Z-9-tetradecenyl acetate | 15.05 | 15.05 | 20.5 | 20.5 |
| Steposol ME | 5.0 | 5.0 | 6.0 | 6.0 |
| Reax 88B | 0.8 | 0.8 | 1.1 | 1.1 |
| Papi 27 | 2.8 | 2.8 | 3.4 | 3.4 |
| Hexamethylene diamine | 1.19 | 1.19 | 1.42 | 1.42 |
| Propylene glycol | 5.0 | 5.0 | 4.5 | 4.5 |
| Rhodopol 23 | 0.16 | 0.16 | 0.16 | 0.16 |
| Proxel GXL | 0.16 | 0.16 | 0.16 | 0.16 |
| Acetic acid | 1.2 | 1.2 | 1.2 | 1.2 |
| Other ingredients (e.g., water, pH | To | To | To | Tc |
| Buffer, xanthan gum, biocide) | 100% | 100% | 100% | 100% |
| Particle size (DV10), μm | 6.12 | 2.34 | 4.14 | 2.44 |
| Particle size (DV50), μm | 23.85 | 12.78 | 21.92 | 15.97 |
| Particle size (DV90), μm | 41.08 | 21.3 | 39.77 | 29.18 |
| % Volatility control at 26 hours of | 82 | 64 | 78 | 65 |
| simulated sunlight (wt %) | | | | |
| Volatility control at 44 hours of | 56 | 21 | 55 | 38 |
| simulated sunlight (wt %) | | | | |

### Example 11. Storage Stability of Microencapsulated Z9-14 Acetate Formulations

Accelerated storage stability tests were conducted on the 200 g/L CS formulation containing antifreeze and using Steposol ME as the solvent. It was discovered that the formulation was flowable at both high and low temperatures (54° C. for 2 weeks, 0° C. for 2 weeks, and freeze-thaw cycle (30° C. to −20° C.) (FT) for 2 weeks. Syneresis (i.e., % separation) was observed for formulations using lower amounts of a rheology modifier blend containing 2% xanthan gum, 2% biocide, and 96% water. As shown in the below table, when the rheology modifier blend is used at a loading level of equal or above 6%, syneresis was below 5% after storing the formulation at 54° C. for 2 weeks. No syneresis is observed at other storage stability conditions. Incorporation of antifreeze improved volatility control for the pheromone as discussed above, and also aided in storage stability and handling characteristics of the pheromone CS formulation.

In the below table, the effect of the rheology modifier, xanthan gum (as Rhodopol 23) on syneresis of the CS formulations after 2 weeks at room temperature, 40° C. and 54° C. is shown. Flowable formulations are obtained after aging the CS formulations of different particle sizes under different conditions. Syneresis is mitigated by the incorporation of appropriate amount of xanthan gum (Rhodopol 23) in the recipe.

TABLE 11
Storage stability of microencapsulated Z9-14 acetate formulations.

| | J-1 | J-2 | J-3 | J-4 | J-5 | J-6 | J-7 | J-8 | J-9 | J-10 | J-11 |
|---|---|---|---|---|---|---|---|---|---|---|---|
| Z-9-Tetradecenyl | 20.5 | 20.5 | 20.5 | 20.5 | 20.5 | 20.5 | 20.5 | 20.5 | 20.5 | 20.5 | 20.5 |
| acetate, wt % | | | | | | | | | | | |
| Rhodopol 23, wt % | 0.12 | 0.14 | 0.16 | 0.06 | 0.09 | 0.12 | 0.06 | 0.09 | 0.12 | 0.14 | 0.16 |
| Rest of formulation | To | To | To | To | To | To | To | To | To | To | To |
| | 100% | 100% | 100% | 100% | 100% | 100% | 100% | 100% | 100% | 100% | 100% |
| d50 (μm) | 12.9 | 12.9 | 12.9 | 16 | 16 | 16 | 22.3 | 22.4 | 21.9 | 21.9 | 21.9 |
| d90 (μm) | 24.1 | 24.1 | 24.1 | 29.3 | 29.2 | 29.2 | 40 | 40.2 | 39.8 | 39.8 | 39.8 |
| Viscosity after 2 | 608 | 890 | 995 | 355 | 361 | 564 | 216 | 356 | 664 | 851 | 1008 |
| weeks at 54° C., | | | | | | | | | | | |
| Brookfield, 30 RPM | | | | | | | | | | | |
| (cP) | | | | | | | | | | | |
| Viscosity after 2 | 515 | 763 | 790 | 259 | 372 | 560 | 228 | 420 | 603 | 803 | 935 |
| weeks at 20° C., | | | | | | | | | | | |
| Brookfield, 30 RPM | | | | | | | | | | | |
| (cP) | | | | | | | | | | | |
| Syneresis after 2 | 2.2 | 1.1 | 0 | 23 | 0 | 0 | 31 | 13 | 6.2 | 4.3 | 1.1 |
| weeks at 54° C. (%) | | | | | | | | | | | |
| Syneresis after 2 | 0.2 | 0 | 0 | 0 | 0 | 0 | 12 | 3 | 2 | 0.2 | 0 |
| weeks at 40° C. (%) | | | | | | | | | | | |
| Syneresis after 2 | 0 | 0 | 0 | 0 | 0 | 0 | 2 | 0 | 0 | 0 | 0 |
| weeks at 20° C. (%) | | | | | | | | | | | |

It was surprisingly discovered herein that substantial improvements in volatility control of pheromone compositions could be achieved with compositions including an antifreeze and microcapsules, where the microcapsules are relatively large and contain co-encapsulated pheromones and solvents. The most substantial improvements were observed with microcapsules having d90 values of at least 35 μm.

1. A composition comprising:
an antifreeze agent; and
a microcapsule comprising:
a core comprising:
a pheromone; and
a solvent; and
a shell encapsulating the core;
wherein the microcapsule has a d90 value of at least about 30 μm.

2. The composition of claim 1, wherein the microcapsule has:
a d90 value in a range of from about 30 μm to about 60 μm;
a d50 value in a range of from about 15 μm to about 25 μm; and/or
a d10 value in a range of from about 2 μm to about 7 μm.

3. The composition of claim 1, wherein the composition further comprises an auxiliary selected from the group consisting of dispersants, surfactants, emulsifiers, wetting agents, biocides, antifoamers, antifreeze agents, rheology modifiers, solvents, stabilizers, UV stabilizers, UV absorbers, salts, excipients, antioxidants, and combinations thereof.

4. The composition of claim 1, wherein the composition is an agrochemical composition.

5. The composition of claim 1, wherein the composition is in a form of a CS formulation or a ZC formulation.

6. The composition of claim 1, wherein the shell comprises a material selected from the group consisting of synthetic polymers, polyureas, polyurethanes, polyacrylates, polyamides, polyvinyl alcohols, polyvinylpyrrolidones, polycarbonates, polythiocarbonates, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

7. The composition of claim 1, wherein the pheromone is selected from the group consisting of aldehyde pheromones, acetate pheromones, alcohol pheromones, ketone pheromones, epoxide pheromones, hydrocarbon pheromones, ester pheromones, and combinations thereof.

8. The composition of claim 1, wherein the pheromone is selected from the group consisting of (Z)-5-decenyl acetate, dodecanyl acetate, (Z)-7-dodecenyl acetate, (E)-7-dodecenyl acetate, (Z)-8-dodecenyl acetate, (E)-8-dodecenyl acetate, (Z)-9-dodecenyl acetate, (E)-9-dodecenyl acetate, (E)-10-dodecenyl acetate, 11-dodecenyl acetate, (Z)-9,11-dodecadienyl acetate, (E)-9,11-dodecadienyl acetate, (Z)-11-tridecenyl acetate, (E)-11-tridecenyl acetate, tetradecanyl acetate, (E)-7-tetradecenyl acetate, (Z)-8-tetradecenyl acetate, (E)-8-tetradecenyl acetate, (Z)-9-tetradecenyl acetate, (E)-9-tetradecenyl acetate, (Z)-10-tetradecenyl acetate, (E)-10-tetradecenyl acetate, (Z)-11-tetradecenyl acetate, (E)-11-tetradecenyl acetate, (Z)-12-pentadecenyl acetate, (E)-12-pentadecenyl acetate, hexadecanyl acetate, (Z)-7-hexadecenyl acetate, (Z)-11-hexadecenyl acetate, (E)-11-hexadecenyl acetate, octadecanyl acetate, (E,Z)-7,9-dodecadienyl acetate, (Z,E)-7,9-dodecadienyl acetate, (E,E)-7,9-dodecadienyl acetate, (Z,Z)-7,9-dodecadienyl acetate, (E,E)-8,10-dodecadienyl acetate, (E,Z)-9,12-dodecadienyl acetate, (E,Z)-4,7-tridecadienyl acetate, (E,E)-9,11-tetradecadienyl acetate, (Z,Z)-9,12-tetradecadienyl acetate, (Z,Z)-7,11-hexadecadienyl acetate, (E,Z)-7,11-hexadecadienyl acetate, (Z,E)-7,11-hexadecadienyl acetate, (E,E)-7,11-hexadecadienyl acetate, (Z,E)-3,13-octadecadienyl acetate, (E,Z)-3,13-octadecadienyl acetate, (E,E)-3,13-octadecadienyl acetate, (Z)-5-decenyl 3-methylbutanoate, (+) cis-7,8-epoxy-2-methyloctadecane, methyl (E,Z)-2,4-decadienoate, methyl 2,6,10-trimethyltridecanoate, and combinations thereof.

9. The composition of claim 1, wherein the antifreeze agent is selected from the group consisting of propylene glycol, glycerin, glycols, ethylene glycol, 1,2-butane diol, 1,3-butane diol, 2,3-butanediol, 1,4-butanediol, methanol, ethanol, propanol, butanol, and combinations thereof.

10. The composition of claim 1, wherein the solvent is selected from the group consisting of hydrophobic solvents, high flashpoint-type solvents, methylated seed oils, methyl oleate methyl ester oil, methyl linoleate methyl ester oil, mineral oils, paraffinic oil, tall oil fatty acid-based solvents, aromatic solvents, aromatic ester solvents, polybutenes, methyl esters of fatty acids, tributyl 2-acetate citrate, alkylamide, benzyl acetate, wax esters, and combinations thereof.

11. A method of making a composition, the method comprising:
forming a mixture comprising:
an antifreeze agent; and
a microcapsule comprising:
a core comprising:
a pheromone; and
a solvent; and
a shell encapsulating the core;
wherein the microcapsule has a d90 value of at least about 30 μm.

12. The method of claim 11, wherein the method further comprises encapsulating the pheromone and the solvent in the microcapsule prior to forming the mixture.

13. A method for controlling a pest comprising contacting the pest or its environment with a biologically effective amount of a composition comprising:
an antifreeze agent; and
a microcapsule comprising:
a core comprising:
a pheromone; and
a solvent; and
a shell encapsulating the core;
wherein the microcapsule has a d90 value of at least about 30 μm.

14. The method of claim 13, wherein the pest is selected from the group consisting of invertebrate pests, insects, arthropods, and combinations thereof.

15. The method of claim 13, wherein the environment is selected from the group consisting of agricultural fields, orchards, forests, and combinations thereof.

16. The composition of claim 1, wherein the microcapsule has a d90 value in a range of from about 35 μm to about 50 μm.

17. The composition of claim 1, wherein the composition is an agrochemical composition in a form selected from the group consisting of a premix and a tank mix.
